(19) United States
(12) Patent Application Publication
(10) Pub. No.: US 2026/0204799 A1
(43) Pub. Date: Jul. 16, 2026

(54) RADIO WAVE REFLECTOR

(71) Applicant: ALPS ALPINE CO., LTD., Tokyo (JP)

(72) Inventors: Yuanzhu DOU, Miyagi (JP); Nagako IWAI, Novi, MI (US); Takashi NAKAYAMA, Tokyo (JP); Kenji TANIOKA, Kanagawa (JP); Yoshiharu SAITO, Fukushima (JP)

(21) Appl. No.: 19/556,261

(22) Filed: Mar. 4, 2026

Related U.S. Application Data
(63) Continuation of application No. PCT/JP2024/007947, filed on Mar. 4, 2024.

(30) Foreign Application Priority Data
Sep. 11, 2023 (JP) 2023-146951

(51) Int. Cl. H01Q 15/14; H01Q 21/06

(52) U.S. Cl. CPC H01Q 15/14; H01Q 21/065

(57) ABSTRACT

A radio wave reflector includes two first antenna elements provided along a first direction, a first transmission line connecting the two first antenna elements, two second antenna elements arranged at positions equidistant from a center point between the two first antenna elements in the first direction and sandwich the two first antenna elements along the first direction, and a second transmission line connecting the two second antenna elements. A difference in electrical length between the first transmission line and the second transmission line is λe×N, where λe denotes a transmission wavelength of radio waves transmitted and received by the two first antenna elements and the two second antenna elements in electrical length, and N denotes an arbitrary natural number.

### CROSS-REFERENCE TO RELATED APPLICATIONS

This application is a continuation application of International Application No. PCT/JP 2024/007947 filed on Mar. 4, 2024 and designated the U.S., which is based upon and claims priority to Japanese Patent Application No. 2023-146951, filed on Sep. 11, 2023, the entire contents of which are incorporated herein by reference.

### BACKGROUND OF THE INVENTION

### 1. Field of the Invention

The present disclosure relates to radio wave reflectors.

### 2. Description of the Related Art

Conventionally, there is a radio wave retroreflector that retroreflects transmitted radio waves, including a plurality of antenna elements that are arranged in a matrix to form an antenna array, and a plurality of transmission lines that connect a plurality of pairs of antenna elements selected from the plurality of antenna elements, where the plurality of pairs of antenna elements are arranged in point-symmetric positions with respect to a center of the antenna array, and the plurality of transmission lines connects the plurality of pairs of antenna elements with equal electrical lengths. Two antenna elements located at point-symmetric positions with respect to the center form the pair of antenna elements (for example, refer to Japanese Laid-Open Patent Publication No. 2017-204681).

In the conventional radio wave retroreflector (radio wave reflector), two antenna elements located at point-symmetrical positions with respect to the center of the matrix are connected to all of the antenna elements by the plurality of transmission lines with equal electrical lengths. For this reason, the plurality of transmission lines intersect each other on surfaces of the plurality of antenna elements, and desired reflection characteristics as a radio wave reflector may not be obtainable due to interference or impedance mismatch between the plurality of transmission lines.

### SUMMARY OF THE INVENTION

Accordingly, one object of the present disclosure is to provide a radio wave reflector with favorable reflection characteristics without having to arrange transmission lines to intersect one another.

A radio wave reflector according to one embodiment of the present disclosure includes two first antenna elements provided along a first direction; a first transmission line connecting the two first antenna elements; two second antenna elements arranged at positions equidistant from a center point between the two first antenna elements in the first direction and sandwich the two first antenna elements along the first direction; and a second transmission line connecting the two second antenna elements, wherein a difference in electrical length between the first transmission line and the second transmission line is λe×N, where λe denotes a transmission wavelength of radio waves transmitted and received by the two first antenna elements and the two second antenna elements in electrical length, and N denotes an arbitrary natural number.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of a radio wave reflector according to a first embodiment;

FIG. 2 is a diagram for explaining lengths of three transmission lines of the radio wave reflector according to the first embodiment;

FIG. 3A is a diagram illustrating an example of a configuration of the radio wave reflector according to a first modification of the first embodiment;

FIG. 3B is a diagram illustrating an example of a configuration of the radio wave reflector according to a second modification of the first embodiment;

FIG. 4A is a diagram illustrating an example of a configuration of the radio wave reflector according to a third modification of the first embodiment;

FIG. 4B is a diagram illustrating an example of measured values of angular characteristics of radar cross section in the radio wave reflector according to the third modification of the first embodiment;

FIG. 4C is a diagram illustrating an example of simulation results of the angular characteristics of the radar cross section in a simulation model of the radio wave reflector according to the third modification of the first embodiment;

FIG. 5A is a diagram illustrating an example of a configuration of the radio wave reflector according to a fourth modification of the first embodiment;

FIG. 5B is a diagram illustrating the example of the configuration of the radio wave reflector according to a fourth modification of the first embodiment;

FIG. 6A is a diagram illustrating an example of a configuration of the radio wave reflector according to a fifth modification of the first embodiment;

FIG. 6B is a diagram illustrating an example of the configuration of the radio wave reflector according to the fifth modification of the first embodiment;

FIG. 6C is a diagram illustrating an example of the configuration of the radio wave reflector according to the fifth modification of the first embodiment;

FIG. 7A is a diagram illustrating an example of a configuration of the radio wave reflector according to a sixth modification of the first embodiment;

FIG. 7B is a diagram illustrating an example of the configuration of the radio wave reflector according to the sixth modification of the first embodiment;

FIG. 7C is a diagram illustrating an example of the configuration of the radio wave reflector according to the sixth modification of the first embodiment;

FIG. 7D is a diagram illustrating an example of the configuration of the radio wave reflector according to the sixth modification of the first embodiment;

FIG. 7E is a diagram illustrating an example of the configuration of the radio wave reflector according to the sixth modification of the first embodiment;

FIG. 8A is a diagram illustrating an example of a configuration of the radio wave reflector according to a seventh modification of the first embodiment;

FIG. 8B is a diagram illustrating an example of the configuration of the radio wave reflector according to the seventh modification of the first embodiment;

FIG. 9A is a diagram illustrating an example of a configuration of the radio wave reflector according to a second embodiment; and

FIG. 9B is a diagram illustrating an example of the configuration of the radio wave reflector according to the second embodiment.

### DESCRIPTION OF THE PREFERRED EMBODIMENTS

Hereinafter, embodiment applied with a radio wave reflector according to the present disclosure will be described. In the following description, the same elements are designated by the same reference numerals, and a redundant description thereof may be omitted.

In the following description, the XYZ coordinate system is defined. A direction parallel to the X axis (X direction), a direction parallel to the Y axis (Y direction), and a direction parallel to the Z axis (Z direction) are perpendicular to one another. The XYZ coordinate system is an example of an orthogonal coordinate system. A view of the XY plane view is referred to as a plan view. In the following description, the X direction may be referred to as a left-right direction, the +Z direction may be referred to as an upward direction, and the −Z direction may be referred to as a downward direction, but these do not represent the universal left-right direction and up-down direction. In the following description, the length, width, thickness, or the like of each part may be exaggerated to facilitate the understanding of the configuration. In addition, the terms such as parallel, right angle, perpendicular, horizontal, vertical, up-down, or the like may tolerate deviations to such an extent that do not deteriorate the advantageous features or effects of the embodiments.

### First Embodiment

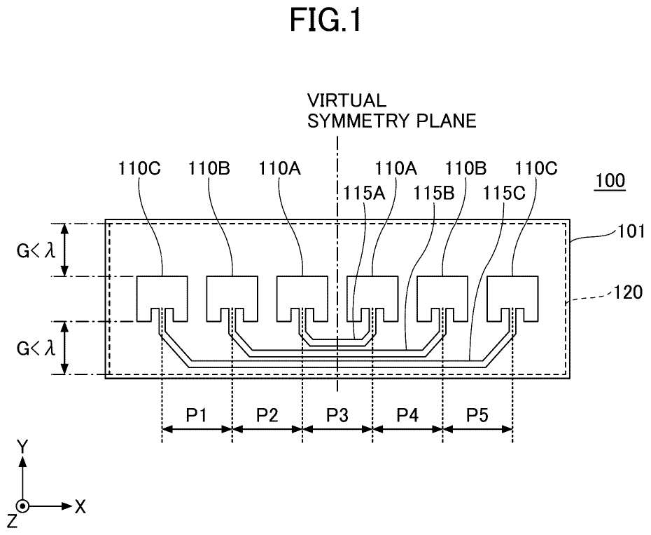

FIG. 1 is a diagram illustrating an example of a configuration of a radio wave reflector 100 according to a first embodiment. The radio wave reflector 100 includes a substrate 101, two antenna elements 110A, two antenna elements 110B, two antenna elements 110C, transmission lines 115A, 115B, and 115C, and a ground layer 120. In the following description, it is assumed that a virtual symmetry plane parallel to the YZ plane is present at a center of the radio wave reflector 100 along the X direction.

### Substrate 101

The substrate 101 is parallel to the XY plane, and the two antenna elements 110A, the two antenna elements 110B, and the two antenna elements 110C are provided along the X direction. The X direction is an example of a first direction, and the Y direction is an example of a second direction.

The substrate 101 may be any type of substrate as long as it is a wiring board capable of supporting a conductive layer. For example, the two antenna elements 110A, the two antenna elements 110B, the two antenna elements 110C, the transmission lines 115A, 115B, and 115C are provided on a surface of the substrate 101 on the +Z direction side, and the ground layer 120 is provided on a surface of the substrate 101 on the −Z direction side. Because the two antenna elements 110A, the two antenna elements 110B, the two antenna elements 110C, the transmission lines 115A, 115B, and 115C, and the ground layer 120 are implemented by conductive layers provided on opposite surfaces of the substrate 101, it is possible to use a printed circuit board having a simple configuration with no inner layers. For example, the conductive layers are made of copper, but the conductive layers may be made of a metal other than copper, such as aluminum or the like.

In addition, the substrate 101 may be a flexible substrate. For example, a substrate having flexibility and formed using a polyimide resin or the like can be used for the flexible substrate. When the substrate 101 has flexibility, the radio wave reflector 100 can be attached to a curved face of an object, such as a curved surface or the like. The substrate 101 may be a multilayer board having inner layers.

### Antenna Elements 110A, 110B, and 110C

The two antenna elements 110A, the two antenna elements 110B, and the two antenna elements 110C are provided on the surface of the substrate 101 on the +Z direction side. The two antenna elements 110A, the two antenna elements 110B, and the two antenna elements 110C are arranged in a left-right symmetrical layout with respect to the virtual symmetry plane in the plan view, and the antenna elements 110A, 110B, and 110C are provided in this order from the side closer to the virtual symmetry plane. Positions of the two antenna elements 110A, the two antenna elements 110B, and the two antenna elements 110C along the Y direction are identical, for example.

The radio wave reflector 100 is a reflector that performs retroreflection to reflect incoming radio waves from various directions on the +Z direction side toward the directions of arrival, for example. For this reason, the antenna elements 110A, 110B, and 110C may be any type of antenna elements as long as the antenna element have a directivity in the +Z direction, but for example, a case where the antenna elements 110A, 110B, and 110C are antenna elements for a patch antenna will be described. The two antenna elements 110A, the two antenna elements 110B, and the two antenna elements 110C constitute the patch antenna together with the ground layer 120. Because the patch antenna has the directivity in the direction (+Z direction) from the ground layer 120 toward the antenna elements 110A, 110B, and 110C, the patch antenna can obtain favorable reflection characteristics.

Further, in a case where the radio wave reflector 100 is used as a reflector for an in-vehicle ultra-wideband radar, for example, the radio wave frequency is 79 GHz, for example. However, usage of the radio wave reflector 100 is not limited to such usage.

A case where the shape of the antenna elements 110A, 110B, and 110C in the plan view is a rectangular shape will be described as an example, but the shape is not limited to the rectangular shape, and may be a circular shape, an elliptical shape, or the like. The antenna elements 110A, 110B, and 110C can be manufactured by patterning a conductive layer formed on the surface of the substrate 101 on the +Z direction side by wet etching or the like, for example.

The two antenna elements 110A are connected by the transmission line 115A. Similarly, the two antenna elements 110B are connected by the transmission line 115B, and the two antenna elements 110C are connected by the transmission line 115C.

The antenna elements 110A, 110B, and 110C have two recesses that are recessed from an end on the −Y direction side toward the center in the plan view, for example, and the transmission lines 115A, 115B, and 115C are connected to a power feeding portion between the two recesses from the −Y direction side, for example. For this reason, an excitation direction of the antenna elements 110A, 110B, and 110C is the Y direction, for example. When the radio wave reflector 100 is used in an upright position so that the +Y direction or the −Y direction is vertically upward, for example, the antenna elements 110A, 110B, and 110C can transmit and receive vertically polarized radio waves. The two recesses sandwiching the power feeding portion are patterns for adjusting an impedance of the antenna elements 110A, 110B, and 110C.

The two antenna elements 110A reflect the radio waves by receiving the radio waves at the antenna element 110A on the −X direction side, propagating signals of the received radio waves to the antenna element 110A on the +X direction side via the transmission line 115A, and transmitting the radio waves from the antenna element 110A on the +X direction side. In addition, the two antenna elements 110A reflect the radio waves by receiving the radio waves at the antenna element 110A on the +X direction side, propagating the signals of the received radio waves to the antenna element 110A on the −X direction side via the transmission line 115A, and transmitting the radio waves from the antenna element 110A on the −X direction side. Accordingly, the two antenna elements 110A perform retroreflection to reflect the incoming radio waves toward the directions of arrival. The same applies to the two antenna elements 110B and the two antenna elements 110C.

For example, the two antenna elements 110A have left-right symmetrical shapes in the plan view, and have identical sizes in the plan view. Similarly, the two antenna elements 110B have left-right symmetrical shapes in the plan view, and have identical sizes in the plan view. Further, the two antenna elements 110C have left-right symmetrical shapes in the plan view, and have identical sizes in the plan view. For example, the shapes and the sizes of the two antenna elements 110A, the two antenna elements 110B, and the two antenna elements 110C in the plan view are all identical, respectively.

The two antenna elements 110A are provided in the left-right symmetrical layout with respect to the virtual symmetry plane in the plan view. That is, the two antenna elements 110A are provided at positions equidistant from the virtual symmetry plane. In this case, equidistant from the virtual symmetry plane means that a distance from a center of one of the antenna elements 110A in the plan view to the virtual symmetry plane is equal to a distance from a center of the other of the antenna elements 110A in the plan view to the virtual symmetry plane, for example. Equidistant may mean that a distance from a center of gravity of one of the antenna elements 110A in the plan view to the virtual symmetry plane is equal to a distance from a center of gravity of the other of the antenna elements 110A in the plan view to the virtual symmetry plane.

The two antenna elements 110B are arranged at positions equidistant from a center point between the two antenna elements 110A in the X direction, and sandwich the two antenna elements 110A along the X direction. That is, the two antenna elements 110B are provided at positions on outer sides of the two antenna elements 110A in the X direction and equidistant from the virtual symmetry plane. In this case, equidistant from the virtual symmetry plane means that a distance from a center of one of the antenna elements 110B in the plan view to the virtual symmetry plane is equal to a distance from a center of the other of the antenna elements 110B in the plan view to the virtual symmetry plane, for example. The distance between the antenna element 110B and the virtual symmetry plane may be a distance from a center of gravity of the antenna element 110B in the plan view to the virtual symmetry plane.

The two antenna elements 110C are arranged at positions equidistant from the center point between the two antenna elements 110A in the X direction, and sandwich the two antenna elements 110A and the two antenna elements 110B along the X direction. That is, the two antenna elements 110C are provided at positions on outer sides of the two antenna elements 110B in the X direction and equidistant from the virtual symmetry plane. In this case, equidistant from the virtual symmetry plane means that a distance from a center of one of the antenna elements 110C in the plan view to the virtual symmetry plane is equal to a distance from a center of the other of the antenna elements 110C in the plan view to the virtual symmetry plane. The distance between the antenna element 110C and the virtual symmetry plane may be a distance from a center of gravity of the antenna element 110C in the plan view to the virtual symmetry plane.

In this example, the two antenna elements 110A and the two antenna elements 110B satisfy a relationship in which the two antenna elements 110A are an example of two first antenna elements and the two antenna elements 110B are an example of two second antenna elements. In this case, the transmission line 115A connecting the two antenna elements 110A is an example of a first transmission line, and the transmission line 115B connecting the two antenna elements 110B is an example of a second transmission line.

In addition, the two antenna elements 110B and the two antenna elements 110C satisfy a relationship in which the two antenna elements 110B are an example of two first antenna elements and the two antenna elements 110C are an example of two second antenna elements. In this case, the transmission line 115B connecting the two antenna elements 110B is an example of a first transmission line, and the transmission line 115C connecting the two antenna elements 110C is an example of a second transmission line.

Further, the two antenna elements 110A and the two antenna elements 110C satisfy a relationship in which the two antenna elements 110A are an example of two first antenna elements and the two antenna elements 110C are an example of two second antenna elements. In this case, the transmission line 115A connecting the two antenna elements 110A is an example of a first transmission line, and the transmission line 115C connecting the two antenna elements 110C is an example of a second transmission line.

That is, the two second antenna elements are arranged at positions equidistant from the center point between the two first antenna elements in the X direction (first direction) and sandwich the two first antenna elements along the X direction (first direction).

A pitch between the antenna element 110C on the −X direction side and the antenna element 110B on the −X direction side is denoted by P1. The pitch refers to a distance between the center in the X direction of the antenna element 110C on the −X direction side and the center in the X direction of the antenna element 110B on the −X direction side. The same applies to the other antenna elements.

A pitch between the antenna element 110B on the −X direction side and the antenna element 110A on the −X direction side is denoted by P2, a pitch between the antenna element 110A on the −X direction side and the antenna element 110A on the +X direction side is denoted by P3, a pitch between the antenna element 110A on the +X direction side and the antenna element 110B on the +X direction side is denoted by P4, and a pitch between the antenna element 110B on the +X direction side and the antenna element 110C on the +X direction side is denoted by P5.

### Transmission Lines 115A, 115B, and 115C

The transmission line 115A connects the two antenna elements 110A. The transmission line 115B connects the two antenna elements 110B, and the transmission line 115C connects the two antenna elements 110C.

The transmission lines 115A, 115B, and 115C can be formed by patterning a conductive layer formed on the surface of the substrate 101 on the +Z direction side by wet etching or the like, for example. The transmission lines 115A, 115B, and 115C extend without intersecting one another in the plan view. Because the transmission lines 115A, 115B, and 115C are arranged without intersecting one another, the six antenna elements 110A, 110B, and 110C can have favorable reflection characteristics.

The transmission line 115A connects the two antenna elements 110A located on an innermost side among the six antenna elements 110B, 110A, and 110C, and thus, the transmission line 115A extends inside a region closest to the two antenna elements 110A in the Y direction among the three transmission lines 115A, 115B, and 115C.

The transmission line 115C connects the two antenna elements 110C located on an outermost side among the six antenna elements 110B, 110C, and 110C, and thus, the transmission line 115C extends inside a region farthest from the two antenna elements 110A in the Y direction among the three transmission lines 115A, 115B, and 115C.

The transmission line 115B connects the two antenna elements 110B located between the two antenna elements 110A located on the innermost side and the two antenna elements 110C located on the outermost side among the six antenna elements 110A, 110B, and 110C, and thus, the transmission line 115B extends inside a region between the region in which the transmission line 115A extends and the region in which the transmission line 115C extends in the Y direction among the three transmission lines 115A, 115B, and 115C.

The transmission line 115A has a characteristic impedance matching an input impedance of the two antenna elements 110A. The transmission line 115B has a characteristic impedance matching an input impedance of the two antenna elements 110B. The transmission line 115C has a characteristic impedance matching an input impedance of the two antenna elements 110C.

When a transmission wavelength (electrical length) of the radio waves transmitted and received by the six antenna elements 110A, 110B, and 110C is denoted by λe and an arbitrary natural number is denoted by N, a difference in electrical length (hereinafter also simply referred to as “length”) between the first transmission line and the second transmission line can be expressed by λe×N. The transmission wavelength (electrical length) is the electrical length of the radio waves in the first transmission line and the second transmission line. That is, a difference between the lengths of the transmission line 115A and the transmission line 115B is λe×N. In other words, when the electrical length of the transmission line 115A is denoted by L, and the difference between the lengths of the transmission line 115A and the transmission line 115B is expressed as described above, the electrical length of the transmission line 115B can be expressed by L+λe×N.

A difference between the lengths of the transmission line 115B and the transmission line 115C can be expressed by λe×N. In other words, when the electrical length of the transmission line 115B is denoted by L, and the difference between the lengths of the transmission line 115B and the transmission line 115C is expressed as described above, the electrical length of the transmission line 115C can be expressed by L+λe×N. In addition, a difference between the lengths of the transmission line 115A and the transmission line 115C can be expressed by λe ×N. In other words, when the electrical length of the transmission line 115A is denoted by L, and the difference between the lengths of the transmission line 115A and the transmission line 115C is expressed as described above, the electrical length of the transmission line 115C can be expressed by L +λe×N. By setting the differences in length as described above, reflection phases of the two antenna elements 110A and the two antenna elements 110B can be aligned. In addition, reflection phases of the two antenna elements 110B and the two antenna elements 110C can be aligned. Moreover, reflection phases of the two antenna elements 110A and the two antenna elements 110C can be aligned.

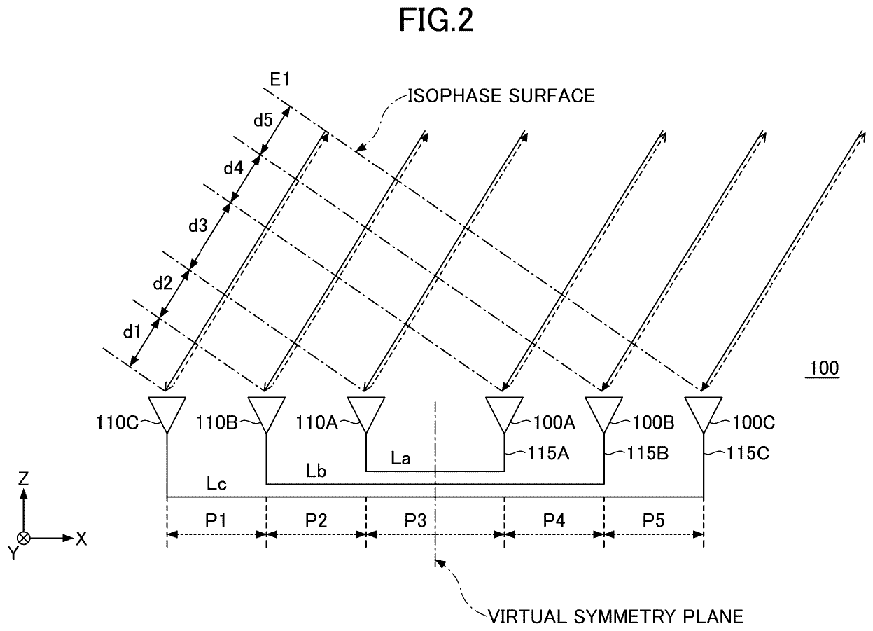

The lengths of the transmission lines 115A, 115B, and 115C will be described with reference to FIG. 2 in addition to FIG. 1. FIG. 2 is a diagram for explaining the lengths of the transmission lines 115A, 115B, and 115C. In FIG. 2, the six antenna elements 110A, 110B, and 110C and the transmission lines 115A, 115B, and 115C are illustrated in a simplified manner, and the illustration of other constituent elements is omitted. The lengths of the transmission lines 115A, 115B, and 115C are denoted by La, Lb, and Lc, respectively. The lengths La, Lb, and Lc are lengths expressed in electrical lengths.

In FIG. 2, it is assumed that incoming radio waves arrive from the +X direction side and the +Z direction side as indicated by solid arrows, and the radio wave reflector 100 reflects the radio waves in the directions indicated by dashed arrows. The directions of arrival of the radio waves and the reflection directions of the radio waves are the same. That is, the directions of arrival of the radio waves with respect to the six antenna elements 110A, 110B, and 110C and the reflection directions of the radio waves are the same. In FIG. 2, six typical isophase surfaces of the incoming radio waves at the six antenna elements 110A, 110B, and 110C and the reflected radio waves are indicated by one-dot chain lines. The six isophase surfaces illustrated in FIG. 2 are isophase surfaces of the radio waves when the six antenna elements 110A, 110B, and 110C receive and reflect the radio waves. The isophase surface for the antenna element 110C on the +X direction side is denoted by E1.

As illustrated in FIG. 2, path differences of the radio waves in the directions of arrival and the reflection directions for two adjacent antenna elements among the six antenna elements 110A, 110B, and 110C are represented by d1, d2, d3, d4, and d5. For the sake of convenience of description, the path differences d1, d2, d3, d4, and d5 are represented by electrical lengths.

For the six antenna elements 110A, 110B, and 110C, a path length of the radio waves arriving through the isophase surface E1 and reflected and passing through the isophase surface E1 is as follows.

The path length for a case where the radio waves are received by the antenna element 110A on the −X direction side and radiated from the antenna element 110A on the +X direction side is as follows.

$$d 5 + d 4 + d 3 + La + d 4 + d 5 = La + d 3 + 2 ( d 4 + d 5 ) \qquad ( 1 )$$

The path length for a case where the radio waves are received by the antenna element 110A on the +X direction side and radiated from the antenna element 110A on the −X direction side is as follows.

$$d 5 + d 4 + La + d 3 + d 4 + d 5 = La + d 3 + 2 ( d 4 + d 5 ) \qquad ( 2 )$$

The path length for a case where the radio waves are received by the antenna element 110B on the −X direction side and radiated from the antenna element 110B on the +X direction side is as follows.

$$d 5 + d 4 + d 3 + d 2 + Lb + d 5 = Lb + d 3 + d 2 + d 4 + 2 d 5 \qquad ( 3 )$$

The path length for a case where the radio waves are received by the antenna element 110B on the +X direction side and radiated from the antenna element 110B on the −X direction side is as follows.

$$d 5 + Lb + d 2 + d 3 + d 4 + d 5 = Lb + d 3 + d 2 + d 4 + 2 d 5 \qquad ( 4 )$$

The path length for a case where the radio waves are received by the antenna element 110C on the −X direction side and radiated from the antenna element 110C on the +X direction side is as follows.

$$d 5 + d 4 + d 3 + d 2 + d 1 + Lc \qquad ( 5 )$$

The path length for a case where the radio waves are received by the antenna element 110C on the +X direction side and radiated from the antenna element 110C on the −X direction side is as follows.

$$Lc + d 1 + d 2 + d 3 + d 4 + d 5 \qquad ( 6 )$$

Because the path length for the case where the radio waves are received by the antenna element 110A on the −X direction side and radiated from the antenna element 110A on the +X direction side is equal to the path length for the case where the radio waves are received by the antenna element 110B on the −X direction side and radiated from the antenna element 110B on the +X direction side, the following relationship stands based on the formulas (1) and (3).

$$La + d 3 + 2 ( d 4 + d 5 ) = Lb + d 3 + d 2 + d 4 + 2 d 5 \qquad ( 7 )$$

In this case, because the difference between the length of the transmission line 115A and the length of the transmission line 115B is λe×N, the following relationship can be obtained from the formula (7) when it is assumed that La=Lb stands for the phases.

$$d 2 = d 4 \qquad ( 8 )$$

Similarly, because the path length for the case where the radio waves are received by the antenna element 110B on the −X direction side and radiated from the antenna element 110B on the +X direction side is equal to the path length for the case where the radio waves are received by the antenna element 110C on the −X direction side and radiated from the antenna element 110C on the +X direction side, the following relationship stands based on the formulas (3) and (5).

$$Lb + d 3 + d 2 + d 4 + 2 d 5 = d 5 + d 4 + d 3 + d 2 + d 1 + Lc \qquad ( 9 )$$

In this case, because the difference between the length of the transmission line 115B and the length of the transmission line 115C is λe×N, the following relationship can be obtained from the formula (9) when it is assumed that Lb=Lc stands for the phases,.

$$d 1 = d 5 \qquad ( 10 )$$

As described above, for the six antenna elements 110A, 110B, and 110C constituting the three pairs, the difference in length of the three transmission lines 115A, 115B, and 115C being λe×N, P2=P4, and P1=P5 are the conditions for the retroreflection. d2=d4 corresponds to P2=P4, and d1=d5 corresponds to P1=P5.

Further, when a phase delay of a signal propagating through the transmission line 115A between the two antenna elements 110A is denoted by φ0, a phase delay of a signal propagating through the transmission line 115B between the two antenna elements 110B can be represented by φ0+λe×N. Similarly, a phase delay of a signal propagating through the transmission line 115C between the two antenna elements 110C can be represented by φ0+λe×N. However, the value of N for the two antenna elements 110B and the value of N for the two antenna elements 110C are different.

For example, in a case where the value of N for the phase delay of the signal propagating through the transmission line 115B is 1 and the value of N for the phase delay of the signal propagating through the transmission line 115C is 2, and when further adding antenna elements on the outer side of the antenna elements 110A through 110C, a length of a transmission line connecting K-th antenna elements when viewed from the antenna elements 110A may be set so that a phase delay of a signal propagating through the transmission line becomes φ0+λe×K.

### Ground Layer 120

The ground layer 120 is formed on substantially the entire surface of the substrate 101 on the −Z direction side. The ground layer 120 overlaps the antenna elements 110A through 110C in the plan view, and an outer edge of the ground layer 120 surrounds the antenna elements 110A through 110C in the plan view. That is, the outer edge of the ground layer 120 surrounds at least two first antenna elements and two second antenna elements.

Further, when a wavelength of the radio waves reflected by the radio wave reflector 100 in free space is denoted by λ, a gap G between the outer edge of the ground layer 120 and outer edges of the antenna elements 110A through 110C in the excitation direction (Y direction) of the antenna elements 110A through 110C is less than λ. That is, G<λ.

When exciting the antenna elements 110A through 110C, an electric field distribution is also generated in the ground layer 120. When the antenna elements 110A through 110C are excited in the Y direction, an electric field distribution that varies in the Y direction is generated in the ground layer 120 due to secondary induced radiation, and radio waves with an opposite phase are radiated from the ground layer 120. When the radio waves with the opposite phase to the phase of the radio waves radiated from the antenna elements 110A through 110C are radiated from the ground layer 120, the radio waves radiated from the antenna elements 110A through 110C are canceled out, and a radiation intensity in the +Z direction is greatly reduced.

For this reason, in order to reduce the radiation of the radio waves from the ground layer 120 and to maintain a large radiation intensity in the +Z direction of the radio waves radiated from the antenna elements 110A through 110C, the gap G between the outer edge of the ground layer 120 and the outer edges of the antenna elements 110A through 110C in the excitation direction (Y direction) of the antenna elements 110A through 110C is set to less than λ. This is because the intensity of the secondary induced radiation generated in the ground layer 120 can be reduced by setting the gap G between the outer edge of the ground layer 120 and the outer edges of the antenna elements 110A through 110C on the ±Y direction side to less than λ.

In addition, because the secondary induced radiation generated in the ground layer 120 is also generated in the X direction, a gap between the outer edge of the ground layer 120 and the outer edge on the −X direction side of the antenna element 110C on the −X direction side is also preferably set to less than λ. Similarly, a gap between the outer edge of the ground layer 120 and the outer edge on the +X direction side of the antenna element 110C on the +X direction side is also preferably set to less than λ.

### Advantageous Features or Effects

The radio wave reflector 100 includes the two antenna elements 110A (two first antenna elements) provided along the X direction (first direction), the transmission line 115A (first transmission line) connecting the two antenna elements 110A, the two antenna elements 110B (two second antenna elements) arranged at the positions that are equidistant from the center point between the two antenna elements 110A in the X direction (first direction) and sandwich the two antenna elements 110A along the X direction (first direction), and the transmission line 115B (second transmission line) connecting the two antenna elements 110B. When the transmission wavelength (electrical length) of the radio waves transmitted and received by the two antenna elements 110A and the two antenna elements 110B is denoted by λe and an arbitrary natural number is denoted by N, the difference in electrical length between the transmission line 115A and the transmission line 115B can be expressed by λe×N.

For this reason, retroreflection can be achieved by aligning the reflected phases of the two antenna elements 110A and the two antenna elements 110B. In addition, because the difference in length between the transmission lines 115A and 115B is λe×N and the transmission line 115B is longer than the transmission line 115A, the transmission lines 115A and 115B can be arranged without intersecting each other. Further, because the transmission lines 115A and 115B can be arranged without intersecting each other, interference and impedance mismatch between the transmission lines 115A and 115B can be suppressed, and favorable reflection characteristics of the two antenna elements 110A and the two antenna elements 110B can be obtained.

Accordingly, it is possible to provide the radio wave reflector 100 in which the transmission lines 115A and 115B can be arranged without intersecting each other and exhibiting favorable reflection characteristics,.

This example describes a case where the two antenna elements 110A are an example of the two first antenna elements, the transmission line 115A is an example of the first transmission line, the two antenna elements 110B are an example of the two second antenna elements, and the transmission line 115B is an example of the second transmission line. However, the same applies to a case where the two antenna elements 110B are an example of the two first antenna elements, the transmission line 115B is an example of the first transmission line, the two antenna elements 110C are an example of the two second antenna elements, and the transmission line 115C is an example of the second transmission line. The same also applies to a case where the two antenna elements 110A are an example of the two first antenna elements, the transmission line 115A is an example of the first transmission line, the two antenna elements 110C are an example of the two second antenna elements, and the transmission line 115C is an example of the second transmission line. Moreover, the same also applies to the advantageous features or effects described below.

In addition, the radio wave reflector may further include the substrate 101 (wiring board), and the two antenna elements 110A, the transmission line 115A, the two antenna elements 110B, and the transmission line 115B may be formed using a conductive layer provided on one surface of the substrate 101. A multilayer board does not need to be used, and a single-sided printed circuit board having the two antenna elements 110A, the transmission line 115A, the two antenna elements 110B, and the transmission line 115B formed on one surface thereof can be used as the substrate 101. The radio wave reflector 100 having a simple configuration and a low manufacturing cost can be provided. Further, by using the single-sided printed circuit board as the substrate 101, the radio wave reflector 100 can be made thin.

Moreover, the radio wave reflector may further include the ground layer 120 provided on the other surface of the substrate 101. It is not necessary to use a multilayer board, and a double-sided printed circuit board having the two antenna elements 110A, the transmission line 115A, the two antenna elements 110B, and the transmission line 115B formed on one surface and the ground layer 120 formed on the other surface can be used as the substrate 101. The radio wave reflector 100 having a simple configuration and a low manufacturing cost can be provided. Further, by using the double-sided printed circuit board as the substrate 101, the radio wave reflector 100 can be made thin.

The two antenna elements 110A, the two antenna elements 110B, and the ground layer 120 may constitute a patch antenna. By using the patch antenna having directivity in the direction from the ground layer 120 toward the two antenna elements 110A and the two antenna elements 110B, the radio wave reflector 100 exhibiting favorable reflection characteristics can be provided.

The outer edge of the ground layer 120 may surround at least two antenna elements 110A and two antenna elements 110B in the plan view, and when the wavelength of the radio wave is denoted by λ, the gap between the outer edge of the ground layer 120 and the outer edges of the two antenna elements 110A and the two antenna elements 110B in the excitation direction (Y direction) of the two antenna elements 110A and the two antenna elements 110B may be less than λ. By reducing the radio waves with the opposite phase due to the secondary inductive radiation generated in the ground layer 120, it is possible to suppress the radio waves radiated from the antenna elements 110A through 110C from being canceled out and to suppress a decrease in the radiation intensity in the +Z direction. For this reason, the radio wave reflector 100 having a large radiation intensity in the +Z direction can be provided.

### First through Seventh Modifications of First Embodiment

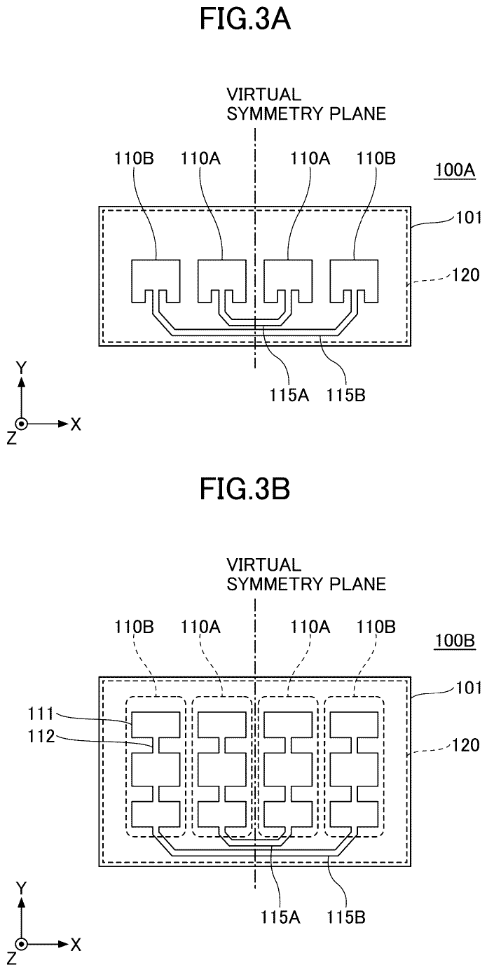

Next, radio wave reflectors according to first through seventh modifications of the first embodiment will be described with reference to FIG. 3A through FIG. 8B, focusing on differences from the radio wave reflector 100 according to the first embodiment illustrated in FIG. 1. The radio wave reflectors according to the first through seventh modifications of the first embodiment can obtain the same advantageous features or effects as those obtainable by the radio wave reflector 100 according to the first embodiment illustrated in FIG. 1 and FIG. 2.

### First Modification

FIG. 3A is a diagram illustrating an example of the configuration of a radio wave reflector 100A according to the first modification of the first embodiment. The radio wave reflector 100A includes a substrate 101, two antenna elements 110A, two antenna elements 110B, transmission lines 115A and 115B, and a ground layer 120. The radio wave reflector 100A differs from the radio wave reflector 100 illustrated in FIG. 1 in that the radio wave reflector 100A does not include the two antenna elements 110C and the transmission line 115C, and the substrate 101 and the ground layer 120 are configured to be small.

The two antenna elements 110A are an example of two first antenna elements, the two antenna elements 110B are an example of two second antenna elements, the transmission line 115A is an example of a first transmission line, and the transmission line 115B is an example of a second transmission line.

A gap between the outer edge of the ground layer 120 and the outer edges of the antenna elements 110A and 110B in the excitation direction (Y direction) of the antenna elements 110A and 110B is less than λ. In addition, a gap between the outer edge of the ground layer 120 and the outer edge on the −X direction side of the antenna element 110B on the −X direction side, and the gap between the outer edge of the ground layer 120 and the outer edge on the +X direction side of the antenna element 110B on the +X direction side are also preferably less than λ.

Because the radio wave reflector 100A according to the first modification has a configuration in which the two antenna elements 110C and the transmission line 115C are omitted from the radio wave reflector 100 illustrated in FIG. 1, the radio wave reflector 100A can operate in the same manner as the four antenna elements 110A and 110B of the radio wave reflector 100 illustrated in FIG. 1, and can achieve retroreflection.

### Second Modification

FIG. 3B is a diagram illustrating an example of the configuration of a radio wave reflector 100B according to the second modification of the first embodiment. The radio wave reflector 100B is obtained by modifying the configuration of the antenna elements 110A and 110B of the radio wave reflector 100A according to the first modification illustrated in FIG. 3A.

The antenna elements 110A and 110B of the radio wave reflector 100B have a configuration in which three rectangular radiating elements 111 arranged in the Y direction are connected by a line 112, for example. Such antenna elements 110A and 110B constitute a patch antenna together with the ground layer 120.

The sizes of the substrate 101 and the ground layer 120 are larger than the substrate 101 and the ground layer 120 illustrated in the FIG. 3A according to the sizes of the antenna elements 110A and 110B. Otherwise, the configuration is the same as that of the radio wave reflector 100A illustrated in FIG. 3A. Even when the antenna elements 110A and 110B having the configuration illustrated in FIG. 3B is used, the radio wave reflector 100B can operate in the same manner as the radio wave reflector 100A according to the first modification illustrated in FIG. 3A, and can achieve retroreflection.

### Third Modification

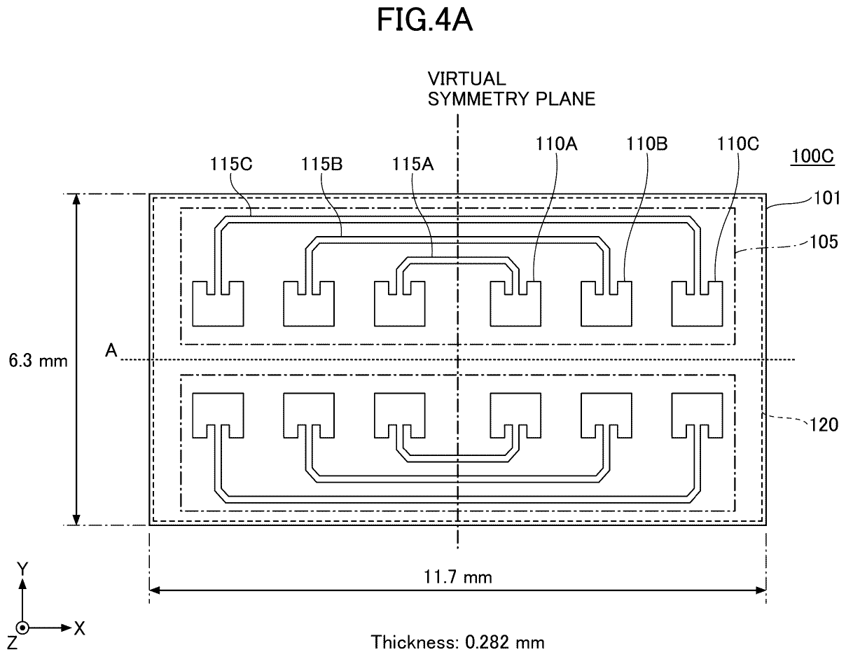

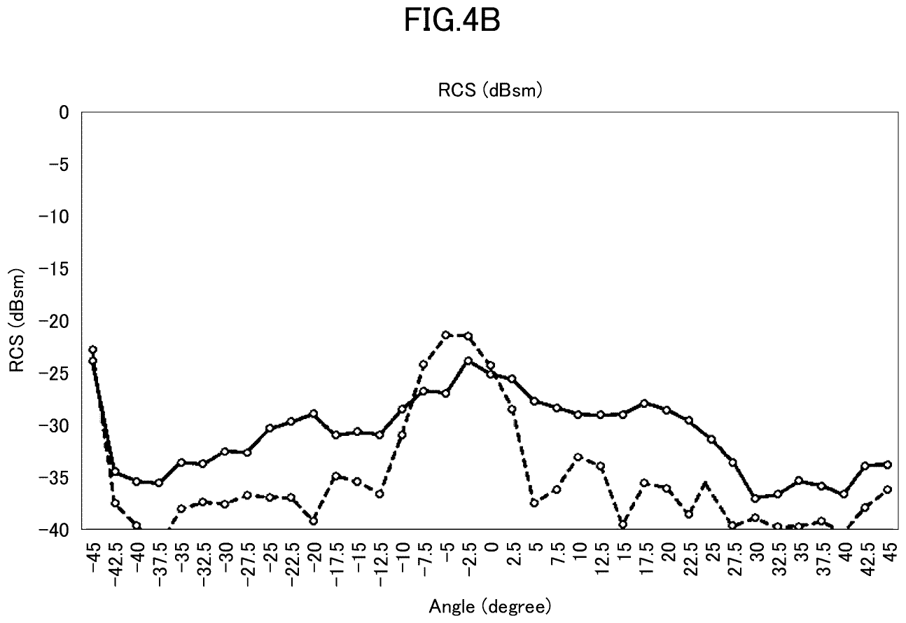

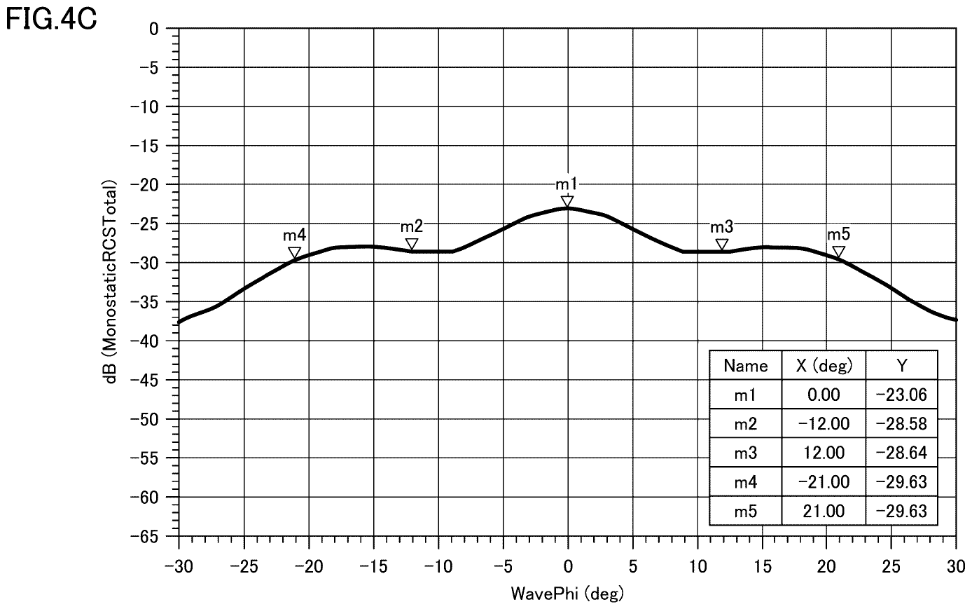

FIG. 4A is a diagram illustrating an example of the configuration of a radio wave reflector 100C according to the third modification of the first embodiment. The radio wave reflector 100C includes two antenna elements 110A, two antenna elements 110B, two antenna elements 110C, and two transmission lines 115A and 115B, and also includes the substrate 101 and the ground layer 120.

The two antenna elements 110A, the two antenna elements 110B, the two antenna elements 110C, and the transmission lines 115A and 115B constitute antennas 105. The radio wave reflector 100C includes two antennas 105. The configurations of the two antenna elements 110A, the two antenna elements 110B, the two antenna elements 110C, and the transmission lines 115A and 115B in the two antennas 105 are identical to the configurations of the two antenna elements 110A, the two antenna elements 110B, the two antenna elements 110C, and the transmission lines 115A and 115B of the radio wave reflector 100 illustrated in FIG. 1.

The two antennas 105 are provided side by side in the Y direction. The arrangement of the two antenna elements 110A, the two antenna elements 110B, the two antenna elements 110C, and the transmission lines 115A and 115B in the antenna 105 on the −Y direction side is the same as the arrangement of the two antenna elements 110A, the two antenna elements 110B, the two antenna elements 110C, and the transmission lines 115A and 115B of the radio wave reflector 100 illustrated in FIG. 1.

The arrangement of the two antenna elements 110A, the two antenna elements 110B, the two antenna elements 110C, and the transmission lines 115A and 115B in the antenna 105 on the +Y direction side is mirror symmetric to the arrangement of the two antenna elements 110A, the two antenna elements 110B, the two antenna elements 110C, and the transmission lines 115A and 115B in the antenna 105 on the −Y direction side, with respect to a straight line A that passes through centers of the two antennas 105 in the Y direction and is parallel to the X axis. For example, the ground layer 120 is common to the two antennas 105.

In a case where the frequency of the radio waves transmitted and received by the radio wave reflector 100C is 79 GHz, for example, a length of the substrate 101 in the X direction is 11.7 mm, a length of the substrate 101 in the Y direction is 6.3 mm, and a thickness of the radio wave reflector 100C in the Z direction is 0.282 mm, for example. The substrate 101 is a flexible substrate made of polyimide.

As described above, the radio wave reflector 100C according to the third modification can be manufactured to be very thin. When the substrate 101 is a flexible substrate, the substrate 101 can easily be attached to a curved surface or the like.

FIG. 4B is a diagram illustrating an example of measured values of angular characteristics of radar cross section in the radio wave reflector 100C according to the third modification. In FIG. 4B, the abscissa indicates an angle of the radio waves, and the ordinate indicates a radar cross section (RCS) of the reflected waves. The angle of the radio waves is a reflection angle of the retroreflection on the XZ plane, and is equal to the angle of arrival of the radio waves. The direction of 0 degrees is the +Z direction, a positive angle greater than 0 degrees represents an angle inclined to the +X direction side from the +Z direction on the XZ plane, and a negative angle smaller than 0 degrees represents an angle inclined to the −X direction side from the +Z direction on the XZ plane.

In FIG. 4B, the measured values of the angular characteristics of the radar cross section in the radio wave reflector 100C according to the third modification are indicated by a solid line, and measured values of the angular characteristics of the radar cross section in a radio wave reflector for comparison are indicated by a dashed line. The radio wave reflector for comparison is formed of a metal plate having the same area as the radio wave reflector 100C in the plan view.

As illustrated in FIG. 4C, the RCS of the radio wave reflector 100C exceeds −25 dBsm in a front direction where the angle is 0 degrees, and exceeds −30 dBsm within a range of ±25 degrees. In the radio wave reflector for comparison, the RCS greatly decreases to −30 dBsm or less when a range of ±10 degrees is exceeded.

FIG. 4C is a diagram illustrating an example of simulation results of the angular characteristics of the radar cross section in a simulation model of the radio wave reflector 100C according to the third modification. In FIG. 4C, the abscissa indicates the angle of the radio waves, and the ordinate indicates the radar cross section (RCS) of the reflected waves. The angle of the radio waves is a reflection angle of the retroreflection on the XZ plane, and is equal to the angle of arrival of the radio waves. The direction of 0 degrees is the +Z direction, a positive angle greater than 0 degrees represents an angle inclined to the +X direction side from the +Z direction on the XZ plane, and a negative angle smaller than 0 degrees represents an angle inclined to the −X direction side from the +Z direction on the XZ plane.

As illustrated in FIG. 4C, the RCS is approximately −23.06, which is a maximum value in the front direction where the angle becomes 0 degrees, and the RCS is reduced by approximately 6.5 with respect to the front direction within a range of approximately ±20 degrees. It is confirmed that the retroreflection at a sufficiently practical level can be obtained within the range of ±20 degrees.

### Fourth Modification

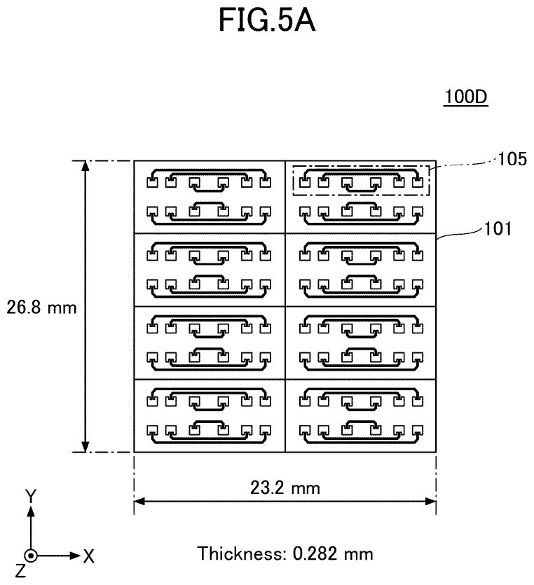

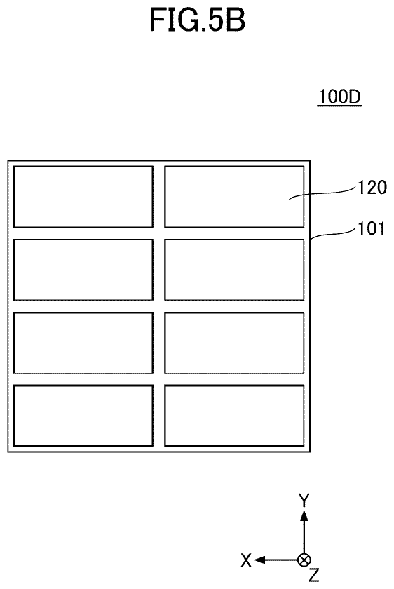

FIG. 5A and FIG. 5B are diagrams illustrating an example of the configuration of a radio wave reflector 100D according to the fourth modification of the first embodiment. The radio wave reflector 100D includes sixteen antennas 105 as illustrated in FIG. 5A. The sixteen antennas 105 includes two antennas arranged in the X direction and eight antennas arranged in the Y direction. The configuration of each antenna 105 is as illustrated in FIG. 4A, and thus, illustration of the reference numerals of the respective constituent elements is omitted in FIG. 5A.

Because the radio wave reflector 100D according to the fourth modification includes the sixteen antennas 105 arranged in a matrix in the X direction and the Y direction, the radio wave reflector 100D having a large area can be provided.

As illustrated in FIG. 5B, a total of eight ground layers 120, including two ground layers arranged in the X direction and four ground layers arranged in the Y direction, are provided. One ground layer 120 is provided with respect to the two antennas 105 disposed in a mirror symmetric layout, as illustrated in FIG. 4A. In other words, the ground layer 120 for the sixteen antennas 105 is divided into eight ground layers 120. By dividing the ground layer 120, it is possible to reduce the influence from the other surrounding antennas 105.

For example, the length of the radio wave reflector 100D illustrated in FIG. 5A in the X direction is 23.2 mm, the length of the radio wave reflector 100D in the Y direction is 26.8 mm, and the thickness of the radio wave reflector 100D in the Z direction is 0.282 mm. The substrate 101 is a flexible substrate made of polyimide, for example. The radio wave reflector 100D according to the fourth modification can be made very thin using the configuration including the sixteen antennas 105. When the substrate 101 is a flexible substrate, the substrate can easily be attached to a curved surface or the like.

### Fifth Modification

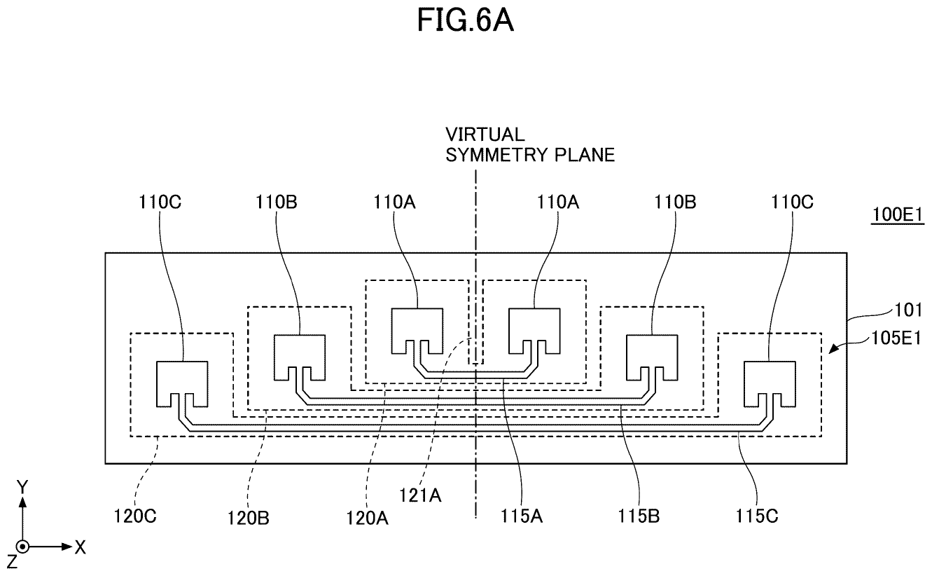

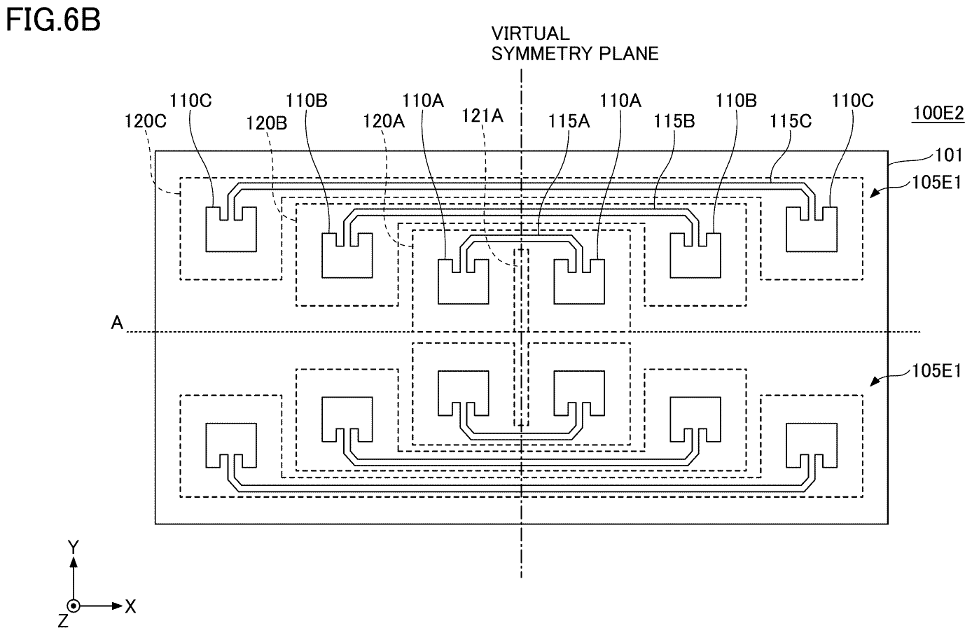

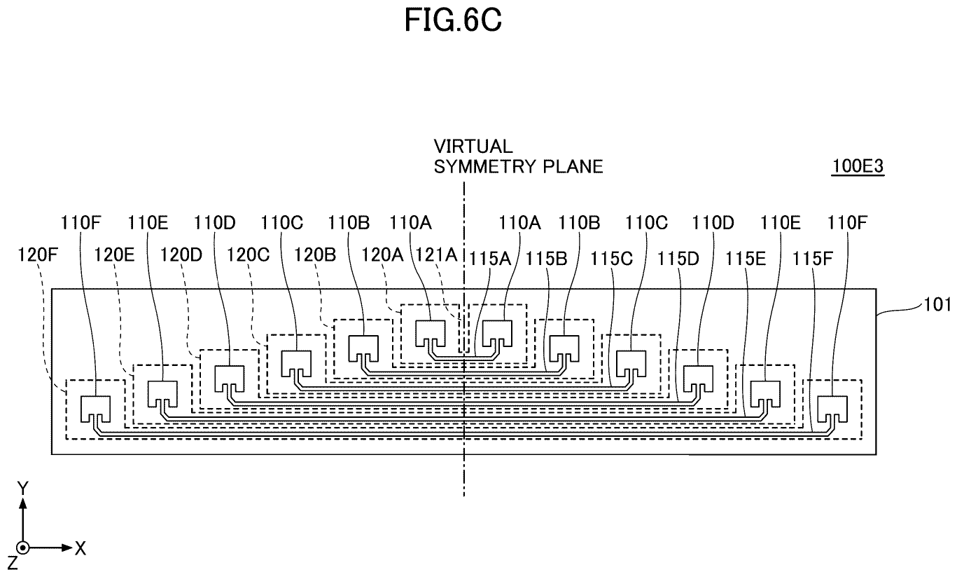

FIG. 6A is a diagram illustrating an example of the configuration of a radio wave reflector 100E1 according to the fifth modification of the first embodiment.

As illustrated in FIG. 6A, the radio wave reflector 100E1 includes a substrate 101, two antenna elements 110A, two antenna elements 110B, two antenna elements 110C, transmission lines 115A, 115B, and 115C, and ground layers 120A, 120B, and 120C. In the radio wave reflector 100E1, the ground layer is divided into three ground layers 120A, 120B, and 120C.

The two antenna elements 110A, the two antenna elements 110B, the two antenna elements 110C, the transmission lines 115A, 115B, and 115C, and the ground layers 120A, 120B, and 120C constitute an antenna 105E1.

The positions of the two antenna elements 110A in the Y direction are identical, for example, the positions of the two antenna elements 110B in the Y direction are identical, for example, and the positions of the two antenna elements 110C in the Y direction are identical, for example. The two antenna elements 110A are located on the most +Y direction side, the two antenna elements 110C are located on the most −Y direction side, and the two antenna elements 110B are located in the middle in the Y direction.

### Ground Layer 120A

The ground layer 120A overlaps the two antenna elements 110A and the transmission line 115A in the plan view. An outer edge of the ground layer 120A surrounds the two antenna elements 110A and the transmission line 115A in the plan view. The ground layer 120A has a shape corresponding to the shape of a region where the two antenna elements 110A and the transmission line 115A are disposed.

The ground layer 120A has a slit 121A provided at a position between the two antenna elements 110A in the plan view. The slit 121A is provided in a recessed shape so as to indent the outer edge of the ground layer 120A from the +Y direction side to the −Y direction side between the two antenna elements 110A. A portion of the ground layer 120A on the −Y direction side of an end portion of the slit 121A on the −Y direction side overlaps the transmission line 115A, and is configured to connect portions of the ground layer 120A overlapping the two antenna elements 110A in the X direction. The slit 121A is provided to reduce the influence of the secondary induced radiation of the two antenna elements 110A on each other and to improve the reflection characteristics. An aperture-shaped slot extending along the Y direction between the two antenna elements 110A may be provided in place of the slit 121A. Even in a case where the slot is provided, the influence of the secondary induced radiation can be reduced and the reflection characteristics can be improved, similar to the case where the slit 121A is provided.

The gap between the outer edge of the ground layer 120A and the outer edges of the antenna elements 110A in the excitation direction (Y direction) of the antenna elements 110A is set to less than λ. This is to reduce the intensity of the secondary induced radiation generated in the ground layer 120A and to increase the radiation intensity in the +Z direction of the radio wave reflector 100E1.

In addition, the gap between the outer edge of the ground layer 120A on the −X direction side and the outer edge on the −X direction side of the antenna element 110A on the −X direction side and the gap between the outer edge of the ground layer 120A on the +X direction side and the outer edge on the +X direction side of the antenna element 110A on the +X direction side are also preferably less than λ.

Moreover, a gap in the X direction between the slit 121A and the two antenna elements 110A is also preferably less than λ.

### Ground Layer 120B

The ground layer 120B overlaps the two antenna elements 110B and the transmission line 115B in the plan view. An outer edge of the ground layer 120B surrounds the two antenna elements 110B and the transmission line 115B in the plan view. The ground layer 120B has a shape corresponding to the shape of a region where the two antenna elements 110B and the transmission line 115B are disposed.

The ground layer 120B has a recessed shape in the plan view so as to avoid the outer edges of the ground layer 120A on the −X direction side, the −Y direction side, and the +X direction side. The ground layer 120B has a shape corresponding to a shape that is obtained by spreading outward the outer edges of the two antenna elements 110B arranged apart from each other in the X direction and the outer edge of the transmission line 115B outward in the plan view, respectively. In other words, the ground layer 120B has a shape corresponding to the shape in which two rectangular portions where the two antenna elements 110B arranged apart from each other in the X direction are disposed are connected by a portion extending in the X direction where the transmission line 115B is disposed.

A gap between the outer edge of the ground layer 120B and the outer edges of the antenna elements 110B in the excitation direction (Y direction) of the antenna element 110B is set to less than λ. This is to reduce the intensity of the secondary induced radiation generated in the ground layer 120B and to increase the radiation intensity in the +Z direction of the radio wave reflector 100E1.

In addition, a gap between the outer edge of the ground layer 120B and the outer edge on the −X direction side of the antenna element 110B on the −X direction side and a gap between the outer edge of the ground layer 120B and the outer edge on the +X direction side of the antenna element 110B on the +X direction side are also preferably less than λ.

In the ground layer 120B, the two portions respectively overlapping the two antenna elements 110B are spaced apart from each other in the X direction, and are connected by an elongated portion overlapping the transmission line 115B. For this reason, the influence of the secondary induced radiation of the two antenna elements 110B on each other can be reduced, and the reflection characteristics can be improved.

### Ground Layer 120C

The ground layer 120C overlaps the two antenna elements 110C and the transmission line 115C in the plan view. An outer edge of the ground layer 120C surrounds the two antenna elements 110C and the transmission line 115C in the plan view. The ground layer 120C has a shape corresponding to the shape of a region where the two antenna elements 110C and the transmission line 115C are disposed.

The ground layer 120C has a recessed shape in the plan view so as to avoid the outer edges of the ground layer 120B on the −X direction side, the −Y direction side, and the +X direction side. The ground layer 120C has a shape corresponding to the planar shape of the two antenna elements 110C arranged apart from each other in the X direction and the transmission line 115C. In other words, the ground layer 120C has a shape corresponding to the shape that is obtained by spreading a portion of the ground layer 120B overlapping the transmission line 115B in the X direction.

A gap between the outer edge of the ground layer 120C and the outer edges of the antenna elements 110C in the excitation direction (Y direction) of the antenna elements 110C is set to less than λ. This is to reduce the intensity of the secondary induced radiation generated in the ground layer 120C and to increase the radiation intensity in the +Z direction of the radio wave reflector 100E1.

In addition, a gap between the outer edge of the ground layer 120C and the outer edge on the −X direction side of the antenna element 110C on the −X direction side and a distance between the outer edge of the ground layer 120C and the outer edge on the +X direction side of the antenna element 110C on the +X direction side are also preferably less than λ.

In the ground layer 120C, the two portions respectively overlapping the two antenna elements 110C are separated from each other in the X direction, and are connected by an elongated portion overlapping the transmission line 115C. For this reason, the influence of the secondary induced radiation of the two antenna elements 110C on each other can be reduced, and the reflection characteristics can be improved.

The radio wave reflector 100E1 described above can be arranged without intersecting the transmission lines 115A, 115B, and 115C. In addition, the radio wave reflector 100E1 includes the ground layers 120A, 120B, and 120C divided in correspondence with the two antenna elements 110A and the transmission line 115A, the two antenna elements 110B and the transmission line 115B, and the two antenna elements 110C and the transmission line 115C, respectively. Moreover, the ground layer 120A overlapping the two antenna elements 110A located at the center along the X direction has the slit 121A extending in the Y direction at the center along the X direction.

Accordingly, it is possible to provide the radio wave reflector 100E1 having the transmission lines 115A, 115B, and 115C that can be arranged without intersecting one another, and exhibiting favorable reflection characteristics. In addition, the influence of the secondary induced radiation of the ground layers 120A, 120B, and 120C is reduced, and the radio wave reflector 100E1 having the favorable reflection characteristics can be obtained.

The radio wave reflector 100E1 described above may be provided with two antennas 105E1. FIG. 6B is a diagram illustrating an example of the configuration of a radio wave reflector 100E2 according to the fifth modification of the first embodiment.

The radio wave reflector 100E2 has a configuration including two antennas 105E1 illustrated in FIG. 6A. The radio wave reflector 100E2 includes two antennas 105E1 and a substrate 101. The substrate 101 is common to the two antennas 105E1.

Each antenna 105E1 includes two antenna elements 110A, two antenna elements 110B, two antenna elements 110C, transmission lines 115A, 115B, and 115C, and ground layers 120A, 120B, and 120C.

The two antennas 105E1 have configurations that are mirror symmetrical with respect to a straight line A that passes through a center of the two antennas 105E1 in the Y direction and is parallel to the X axis. The configuration of the antenna 105E1 on the −Y direction side is identical to the configuration of the antenna 105E1 included in the radio wave reflector 100E1 illustrated in FIG. 6A. The antenna 105E1 on the +Y direction side has a configuration that is mirror symmetrical with respect to the straight line A to the antenna 105E1 on the −Y direction side.

The radio wave reflector 100E2 includes the two antennas 105E1 having the mirror symmetric configuration. Each antenna 105E1 can be arranged without intersecting the transmission lines 115A, 115B, and 115C. For this reason, it is possible to provide the radio wave reflector 100E2 exhibiting favorable reflection characteristics. In addition, the influence of the secondary induced radiation of the ground layers 120A, 120B, and 120C is reduced, and the radio wave reflector 100E2 having the favorable reflection characteristics can be obtained.

The number of antenna elements and the number of ground layers in the radio wave reflector 100E1 may further be increased. FIG. 6C is a diagram illustrating an example of the configuration of a radio wave reflector 100E3 according to the fifth modification of the first embodiment.

The radio wave reflector 100E3 includes two antenna elements 110A, two antenna elements 110B, two antenna elements 110C, two antenna elements 110D, two antenna elements 110E, two antenna elements 110F, transmission lines 115A, 115B, 115C, 115D, 115E, and 115F, and ground layers 120A, 120B, 120C, 120D, 120E, and 120F.

The radio wave reflector 100E3 has a configuration in which the two antenna elements 110D, the two antenna elements 110E, the two antenna elements 110F, the transmission lines 115D, 115E, and 115F, and ground layers 120D, 120E, and 120F are added with respect to the radio wave reflector 100E1 illustrated in FIG. 6A.

The two antenna elements 110D, the transmission line 115D, and the ground layer 120D have a configuration corresponding to that of the two antenna elements 110C, the transmission line 115C, and the ground layer 120C, but as if the transmission line 115C and a portion of the ground layer 120C overlapping the transmission line 115C were spread outward in the X direction. The two antenna elements 110E, the transmission line 115E, and the ground layer 120E have a configuration corresponding to that of the two antenna elements 110D, the transmission line 115D, and the ground layer 120D, but as if the transmission line 115D and a portion of the ground layer 120D overlapping the transmission line 115D were spread outward in the X-direction. The two antenna elements 110F, the transmission line 115F, and the ground layer 120F have a configuration corresponding to that of the two antenna elements 110E, the transmission line 115E, and the ground layer 120E, but as if the transmission line 115E and a portion of the ground layer 120E overlapping the transmission line 115E were spread outward in the X-direction.

Even in the configuration of the radio wave reflector 100E3 in which the number of antenna elements and the number of ground layers are increased compared to those of the radio wave reflector 100E1 (refer to FIG. 6A), the transmission lines 115A through 115F can be arranged without intersecting one another, the influence of the secondary induced radiation of the ground layers 120A through 120F can be reduced, and the radio wave reflector 100E3 exhibiting favorable reflection characteristics can be obtained.

The ground layer may be a single ground layer, without being divided into the six ground layers 120A, 120B, 120C, 120D, 120E, and 120F. In addition, the ground layers 120A, 120B, 120C, 120D, 120E, and 120F may be grouped into an arbitrary number of groups.

### Sixth Modification

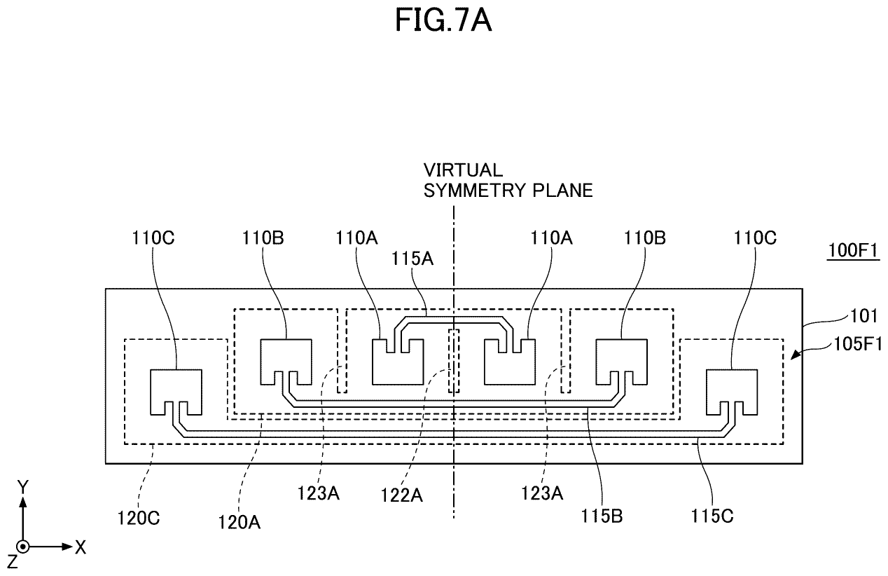

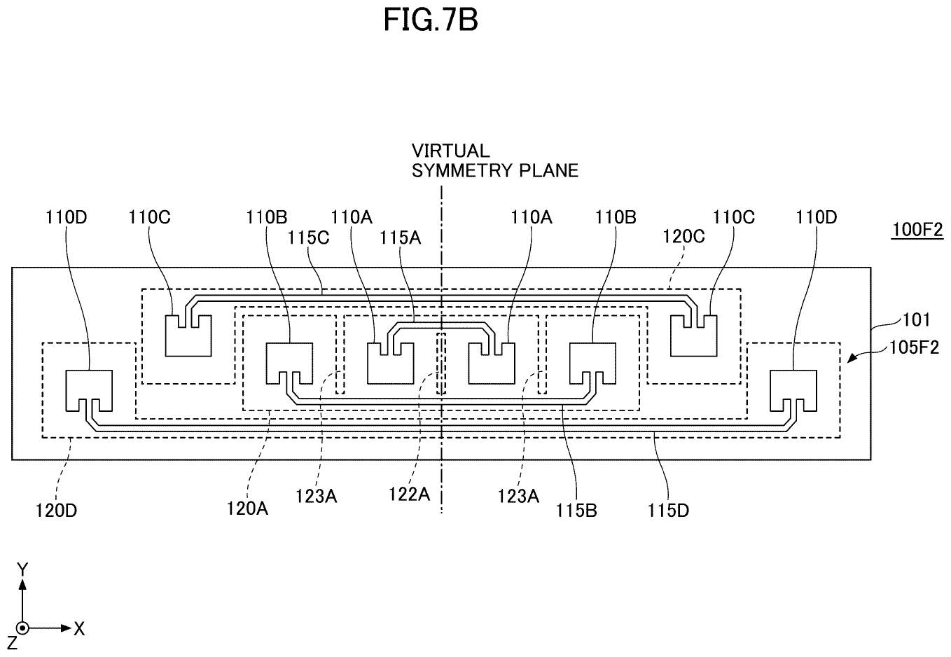

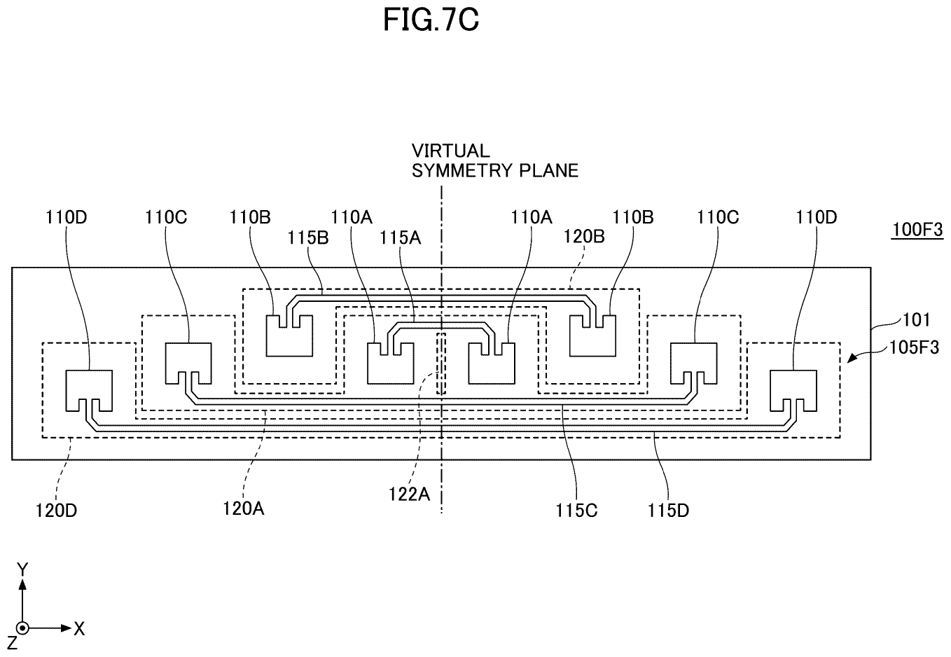

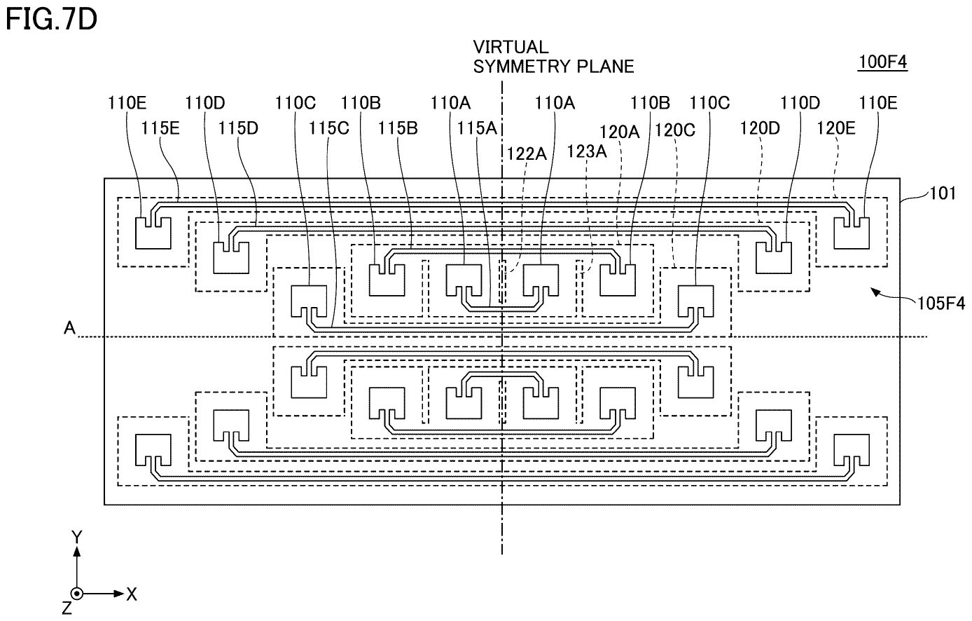

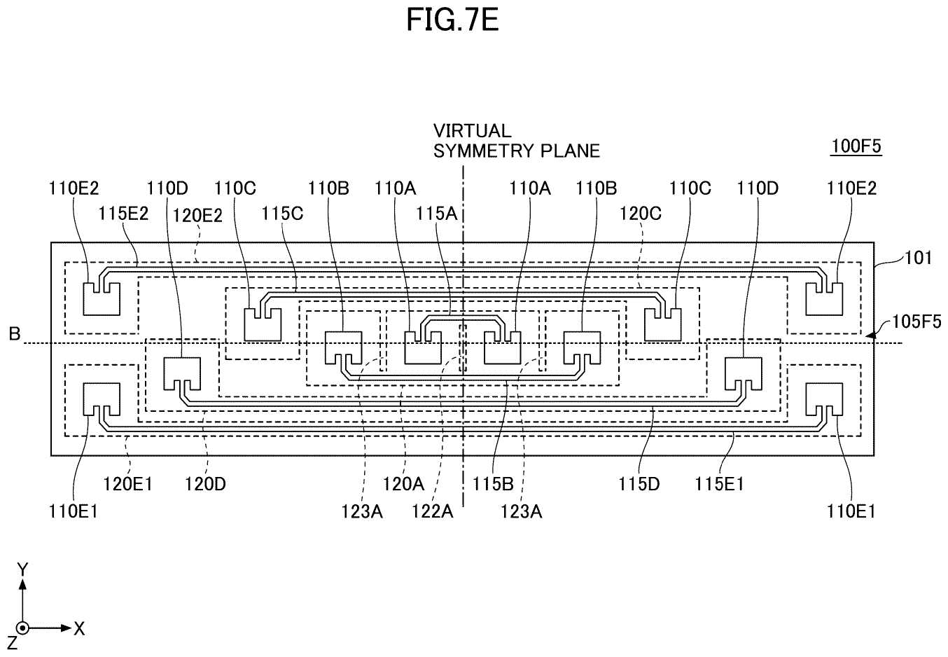

FIG. 7A is a diagram illustrating an example of the configuration of a radio wave reflector 1 00F1 according to the sixth modification of the first embodiment.

As illustrated in FIG. 7A, the radio wave reflector 100F1 includes a substrate 101, two antenna elements 110A, two antenna elements 110B, two antenna elements 110C, transmission lines 115A, 115B, and 115C, and ground layers 120A and 120C. In the radio wave reflector 100F1, the ground layer is divided into two ground layers 120A and 120C.

The two antenna elements 110A, the two antenna elements 110B, the two antenna elements 110C, the transmission lines 115A, 115B, and 115C, and the ground layers 120A and 120C constitute an antenna 105F1.

The two antenna elements 110A of the radio wave reflector 100E1 according to the fifth modification are arranged in a state where the two antenna elements 110A are rotated by 180 degrees in the plan view, and two slots of each of the two antenna elements 110A are recessed from the +Y direction side toward the center thereof. The transmission line 115A extends in the X direction on the +Y direction side of the two antenna elements 110A, and is connected to the two antenna elements 110A from the +Y direction side. For this reason, the two antenna elements 110A are excited in the Y direction. The operation of the two antenna elements 110A of the radio wave reflector 100F1 is identical to the operation of the two antenna elements 110A of the radio wave reflector 100E1 according to the fifth modification.

The arrangement of the two antenna elements 110B and the two antenna elements 110C is the same as the arrangement of the two antenna elements 110B and the two antenna elements 110C of the radio wave reflector 100E1 (refer to FIG. 6A) according to the fifth modification. The connection relationship of the two antenna elements 110B and the transmission line 115B and the connection relationship of the two antenna elements 110C and the transmission line 115C are identical to the connection relationships in the radio wave reflector 100E1 according to the fifth modification.

In the radio wave reflector 100F1, one ground layer 120A is provided with respect to two antenna elements 110A, two antenna elements 110B, and transmission lines 115A and 115B.

The ground layer 120A overlaps the two antenna elements 110A, the two antenna elements 110B, and the transmission lines 115A and 115B in the plan view. An outer edge of the ground layer 120A surrounds the two antenna elements 110A, the two antenna elements 110B, and the transmission lines 115A and 115B in the plan view. The ground layer 120A has a shape corresponding to the shape of a region where the two antenna elements 110A, the two antenna elements 110B, and the transmission lines 115A and 115B are disposed.

The ground layer 120A includes a slot 122A located at a position between the two antenna elements 110A, and two slits 123A located at positions between one of the two antenna elements 110A and one of the two antenna elements 110B and between the other of the two antenna elements 110A and the other of the two antenna elements 110B, respectively.

In addition, a gap between an outer edge of the ground layer 120A and outer edges of the antenna elements 110A and 110B in the excitation direction (Y direction) of the antenna elements 110A and 110B is set to less than λ. This is to reduce the intensity of the secondary induced radiation generated in the ground layer 120A and to increase the radiation intensity in the +Z direction of the radio wave reflector 100F1.

Moreover, a gap between the outer edge of the ground layer 120A and the outer edge on the −X direction side of the antenna element 110B on the −X direction side and a gap between the outer edge of the ground layer 120A and the outer edge on the +X direction side of the antenna element 110B on the +X direction side are also preferably less than λ.

Further, a gap in the X direction between the slot 122A and the two antenna elements 110A, and a gap in the X direction between the slits 123A and the two antenna elements 110A and the two antenna elements 110B, respectively, are also preferably less than λ, respectively.

The radio wave reflector 100F1 described above can arrange the transmission lines 115A, 115B, and 115C without intersecting the transmission lines 115A, 115B, and 115C. In addition, the radio wave reflector 100F1 includes the ground layers 120A and 120C divided in correspondence with the two antenna elements 110A, the two antenna elements 110B, and the transmission lines 115A and 115B on one hand, and the two antenna elements 110C and the transmission line 115C on the other. Moreover, the ground layer 120A has a slot 122A extending in the Y direction at the center along the X direction, and two slits 123A.

Accordingly, it is possible to provide a radio wave reflector 100F1 having the transmission lines 115A, 115B, and 115C that can be arranged without intersecting one another, and exhibiting favorable reflection characteristics. In addition, the influence of the secondary induced radiation of the ground layers 120A and 120C is reduced, and the radio wave reflector 100F1 having favorable reflection characteristics can be obtained.

Moreover, because the ground layer 120A has a configuration in which a portion of the slot 122A on the +Y direction side overlaps the transmission line 115A and a portion of the slot 122A on the −Y direction side overlaps the transmission line 115B, it is possible to dispose the two antenna elements 110A and the two antenna elements 110B at positions close to each other in the Y direction. Further, according to such a configuration, the length of the substrate 101 in the Y direction can be reduced, and a layout density can be improved.

Two antennas 105F1 of such a radio wave reflector 100F1 may be provided. The two antennas 105F1 may be configured in a mirror symmetric layout.

The number of antenna elements and the number of ground layers in the radio wave reflector 100F1 may further be increased.

FIG. 7B is a diagram illustrating an example of the configuration of a radio wave reflector 100F2 according to the sixth modification of the first embodiment.

As illustrated in FIG. 7B, the radio wave reflector 100F2 includes a substrate 101, two antenna elements 110A, two antenna elements 110B, two antenna elements 110C, two antenna elements 110D, transmission lines 115A, 115B, 115C, and 115D, and ground layers 120A, 120C, and 120D. In the radio wave reflector 100F2, the ground layer is divided into three ground layers 120A, 120C, and 120D.

The two antenna elements 110A, the two antenna elements 110B, the two antenna elements 110C, the two antenna elements 110D, the transmission lines 115A, 115B, 115C, and 115D, and the ground layers 120A, 120C, and 120D constitute an antenna 105F2.

The configurations of the two antenna elements 110A, the two antenna elements 110B, the transmission lines 115A and 115B, and the ground layer 120A of the radio wave reflector 100F2 are identical to those of the radio wave reflector 100F1 (refer to FIG. 7A).

In the radio wave reflector 100F2, the two antenna elements 110C are rotated by 180 degrees in the plan view so that the two slots are located on the +Y direction side. In addition, the transmission line 115C extends in the X direction on the +Y direction side of the two antenna elements 110C, and a portion of the ground layer 120C overlapping the transmission line 115C extends in the X direction on the +Y direction side of the ground layer 120A.

The two antenna elements 110D, the transmission line 115D, and the ground layer 120D have a configuration corresponding to that of the two antenna elements 110C, the transmission line 115C, and the ground layer 120C of the radio wave reflector 100F1 illustrated in FIG. 7A, but as if the transmission line 115C and a portion of the ground layer 120C overlapping the transmission line 115C were spread outward in the X direction.

In the radio wave reflector 100F2, the transmission lines 115A and 115C are located at positions on the +Y direction side, and the transmission lines 115B and 115D are located at positions on the −Y direction side, and thus, the length of the substrate 101 in the Y direction can be reduced. In addition, the length of the substrate 101 in the Y direction can also be reduced by making it possible to dispose the two antenna elements 110A, the two antenna elements 110B, the two antenna elements 110C, and the two antenna elements 110D at positions close to one another in the Y direction. According to such a configuration, the layout density of the radio wave reflector 100F2 can be improved.

In addition, with respect to the ground layers 120A, 120C, and 120D, gaps corresponding to the gap G in the radio wave reflector 100 illustrated in FIG. 1 are set to less than λ. This is to reduce the intensity of the secondary induced radiation generated in the ground layers 120A, 120C, and 120D, and to increase the radiation intensity in the +Z direction of the radio wave reflector 100F2.

Moreover, with respect to the ground layers 120A, 120C, and 120D, gaps in the X direction between the outer edges of the antenna elements 110A through 110D and the outer edges of the ground layers 120A, 120C, and 120D are also preferably less than λ.

The radio wave reflector 100F2 described above can arrange the transmission lines 115A through 115D without intersecting the transmission lines 115A through 115D. In addition, the radio wave reflector 100F2 has the divided ground layers 120A, 120C, and 120D. Moreover, the ground layer 120A has a slot 122A extending in the Y direction at the center along the X direction, and two slit 123A.

Accordingly, it is possible to provide the radio wave reflector 100F2 having the transmission lines 115A through 115D that can be arranged without intersecting one another, and exhibiting favorable reflection characteristics. In addition, the influence of the secondary induced radiation of the ground layers 120A, 120C, and 120D is reduced, and the radio wave reflector 100F2 having the favorable reflection characteristics can be obtained.

Two antennas 105F2 of such a radio wave reflector 100F2 may be provided. The two antennas 105F2 may be configured in a mirror symmetric layout.

The number of antenna elements and the number of ground layers in the radio wave reflector 100F2 may further be increased.

FIG. 7C is a diagram illustrating an example of the configuration of a radio wave reflector 100F3 according to the sixth modification of the first embodiment.

As illustrated in FIG. 7C, the radio wave reflector 100F3 includes a substrate 101, two antenna elements 110A, two antenna elements 110B, two antenna elements 110C, two antenna elements 110D, transmission lines 115A, 115B, 115C, and 115D, and ground layers 120A, 120B, and 120D. In the radio wave reflector 100F3, the ground layer is divided into three ground layers 120A, 120B, and 120D.

The two antenna elements 110A, the two antenna elements 110B, the two antenna elements 110C, the two antenna elements 110D, the transmission lines 115A, 115B, 115C, and 115D, and the ground layers 120A, 120B, and 120D constitute an antenna 105F3.

In the radio wave reflector 100F3, the two antenna elements 110A, the two antenna elements 110C, and the transmission lines 115A and 115C are disposed to overlap the common ground layer 120A. In addition, the two antenna elements 110B and the transmission line 115B are disposed to overlap the ground layer 120B, and the two antenna elements 110D and the transmission line 115D are disposed to overlap the ground layer 120D. The configurations of the two antenna elements 110D, the transmission line 115D, and the ground layer 120D are identical to those of the radio wave reflector 100F2.

In the radio wave reflector 100F3, the transmission lines 115A and 115B extend in the X direction on the +Y direction side, and the transmission lines 115C and 115D extend in the X direction on the −Y direction side.

The ground layer 120A includes one rectangular portion in which the two antenna elements 110A are disposed, two rectangular portions in which the two antenna elements 110C are disposed, respectively, and a portion in which the transmission line 115C is disposed and extending in the X direction. The ground layer 120A has a slot 122A extending in the Y direction at the center along the X direction of the one rectangular portion in which the two antenna elements 110A are disposed.

The transmission line 115A extends in the X direction on the +Y direction side of the slot 122A, and the transmission line 115C extends in the X direction on the −Y direction side of the slot 122A.

The configurations of the two antenna elements 110C, the transmission line 115C, and the ground layer 120C, and the configurations of the two antenna elements 110D, the transmission line 115D, and the ground layer 120D are similar to those of the radio wave reflector 100E3 (refer to FIG. 6C) according to the fifth modification of the first embodiment.

In the radio wave reflector 100F3, the transmission lines 115A and 115B are located on the +Y direction side, and the transmission lines 115C and 115D are located on the −Y direction side, and thus, the length of the substrate 101 in the Y direction can be reduced. In addition, the length of the substrate 101 in the Y direction can also be reduced by making it possible to dispose the two antenna elements 110A, the two antenna elements 110B, the two antenna elements 110C, and the two antenna elements 110D at positions close to one another in the Y direction. According to such a configuration, the layout density of the radio wave reflector 100F3 can be improved.

In addition, with respect to the ground layers 120A, 120B, and 120D, gaps corresponding to the gap G in the radio wave reflector 100 illustrated in FIG. 1 are set to less than λ. This is to reduce the intensity of the secondary induced radiation generated in the ground layers 120A, 120B, and 120D and to increase the radiation intensity in the +Z direction of the radio wave reflector 100F3.

Moreover, with respect to the ground layers 120A, 120B, and 120D, gaps in the X direction between the outer edges of the antenna elements 110A through 110D and the outer edges of the ground layers 120A, 120B, and 120D are also preferably less than λ.

The radio wave reflector 100F3 described above can arrange the transmission lines 115A through 115D without intersecting the transmission lines 115A through 115D. In addition, the radio wave reflector 100F3 has the divided ground layers 120A, 120B, and 120D. Further, the ground layer 120A has a slot 122A extending in the Y direction at the center along the X direction.

Accordingly, it is possible to provide the radio wave reflector 100F3 having the transmission lines 115A through 115D that can be arranged without intersecting one another, and exhibiting favorable reflection characteristics. In addition, the influence of the secondary induced radiation of the ground layers 120A, 120B, and 120D is reduced, and the radio wave reflector 100F3 having the favorable reflection characteristics can be obtained.

Two antennas 105F3 of such a radio wave reflector 100F3 may be provided. The two antennas 105F3 may be configured in a mirror symmetric layout.

The number of antenna elements and the number of ground layers in the radio wave reflector 100F3 may further be increased.

FIG. 7D is a diagram illustrating an example of the configuration of a radio wave reflector 100F4 according to the sixth modification of the first embodiment.

As illustrated in FIG. 7D, the radio wave reflector 100F4 includes a substrate 101 and two antennas 105F4. Each antenna 105F4 includes two antenna elements 110A, two antenna elements 110B, two antenna elements 110C, two antenna elements 110D, two antenna elements 110E, transmission lines 115A, 115B, 115C, 115D, and 115E, and ground layers 120A, 120C, 120D, and 120E. In the radio wave reflector 100F4, the ground layer is divided into four ground layers 120A, 120C, 120D, and 120E.

The configurations of the two antenna elements 110A, the two antenna elements 110B, the two antenna elements 110C, the two antenna elements 110D, the transmission lines 115A, 115B, 115C, and 115D, and the ground layers 120A, 120C, and 120D in each antenna 105F4 are identical to the configurations in the antenna 105F2 of the radio wave reflector 100F2 illustrated in FIG. 7B.

The antenna 105F4 has a configuration in which the two antenna elements 110E, the transmission line 115E, and the ground layer 120E are added to the antenna 105F2 illustrated in FIG. 7B. The configurations of the two antenna elements 110E, the transmission line 115E, and the ground layer 120E are identical to those of the radio wave reflector 100E3 (refer to FIG. 6C) according to the fifth modification of the first embodiment.

The two antennas 105F4 have configurations that are mirror symmetric with respect to a straight line A that passes through the center of the two antennas 105F4 in the Y direction and is parallel to the X axis.

The radio wave reflector 100F4 includes the two antennas 105F4 having the mirror symmetric configuration. Each antenna 105F4 can be arranged without intersecting the transmission lines 115A through 115E. For this reason, it is possible to provide the radio wave reflector 100F4 having favorable reflection characteristics. In addition, the influence of the secondary induced radiation of the ground layers 120A, 120C, 120D, and 120E is reduced, and the radio wave reflector 100F4 having favorable reflection characteristics can be obtained.

FIG. 7E is a diagram illustrating an example of the configuration of a radio wave reflector 100F5 according to the sixth modification of the first embodiment.

As illustrated in FIG. 7E, the radio wave reflector 100F5 includes a substrate 101, two antenna elements 110A, two antenna elements 110B, two antenna elements 110C, two antenna elements 110D, two antenna elements 110E1, two antenna elements 110E2, transmission lines 115A, 115B, 115C, 115D, 115E1, and 115E2, and ground layers 120A, 120C, 120D, 120E1, and 120E2. In the radio wave reflector 100F5, the ground layer is divided into five ground layers 120A, 120C, 120D, 120E1, and 120E2.

The two antenna elements 110A, the two antenna elements 110B, the two antenna elements 110C, the two antenna elements 110D, the two antenna elements 110E1, the two antenna elements 110E2, the transmission lines 115A, 115B, 115C, 115D, 115E1, and 115E2, and ground layers 120A, 120C, 120D, 120E1, and 120E2 constitute an antenna 105F5.

The configurations of the two antenna elements 110A, the two antenna elements 110B, the two antenna elements 110C, the two antenna elements 110D, the transmission lines 115A, 115B, 115C, and 115D, and the ground layers 120A, 120C, and 120D in the antenna 105F5 are identical to those of the antenna 105F2 of the radio wave reflector 100F2 illustrated in FIG. 7B.

The antenna 105F5 has a configuration in which the two antenna elements 110E1, the two antenna elements 110E2, the transmission lines 115E1 and 115E2, and ground layers 120E1 and 120E2 and are added to the antenna 105F2 illustrated in FIG. 7B.

The configurations of the two antenna elements 110E1, the transmission line 115E1, and the ground layer 120E1 and the configurations of the two antenna elements 110E2, the transmission line 115E2, and the ground layer 120E2 are mirror symmetric with respect to a straight line B that passes through the center of along the length of the substrate 101 in the Y direction and is parallel to the X direction. The two antenna elements 110E1, the transmission line 115E1, and the ground layer 120E1 are located on the −Y direction side of the straight line B, and the two antenna elements 110E2, the transmission line 115E2, and the ground layer 120E2 are located on the +Y direction side of the straight line B.

The two antenna elements 110E1, the transmission line 115E1, and the ground layer 120E1 have a configuration corresponding to that of the two antenna elements 110D, the transmission line 115D, and the ground layer 120D, but as if the transmission line 115D and a portion of the ground layer 120D overlapping the transmission line 115D were spread outward in the X direction.

Accordingly, it is possible to provide the radio wave reflector 100F5 having the transmission lines 115A through 115E2 that can be arranged without intersecting one another, and exhibiting favorable reflection characteristics. In addition, the influence of the secondary induced radiation of the ground layers 120A, 120C, 120D, 120E1, and 120E2 is reduced, and the radio wave reflector 100F5 having the favorable reflection characteristics can be obtained.

### Seventh Modification

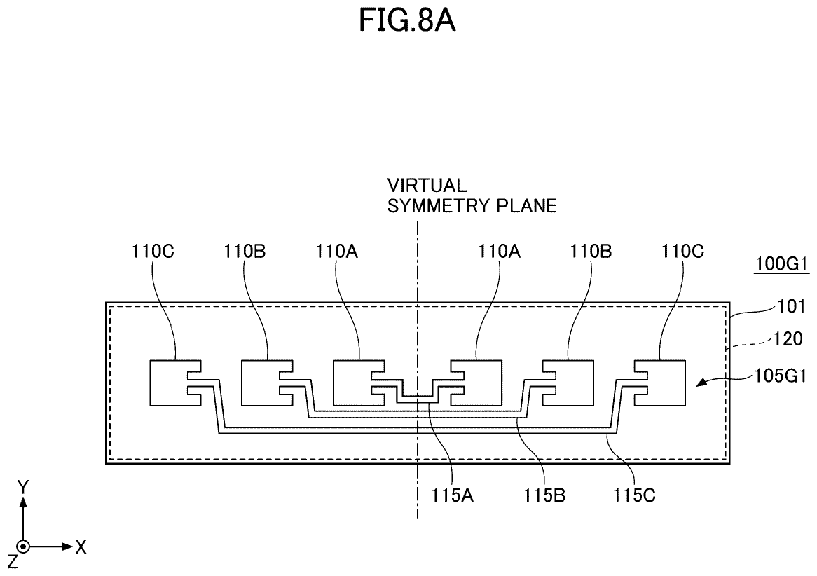

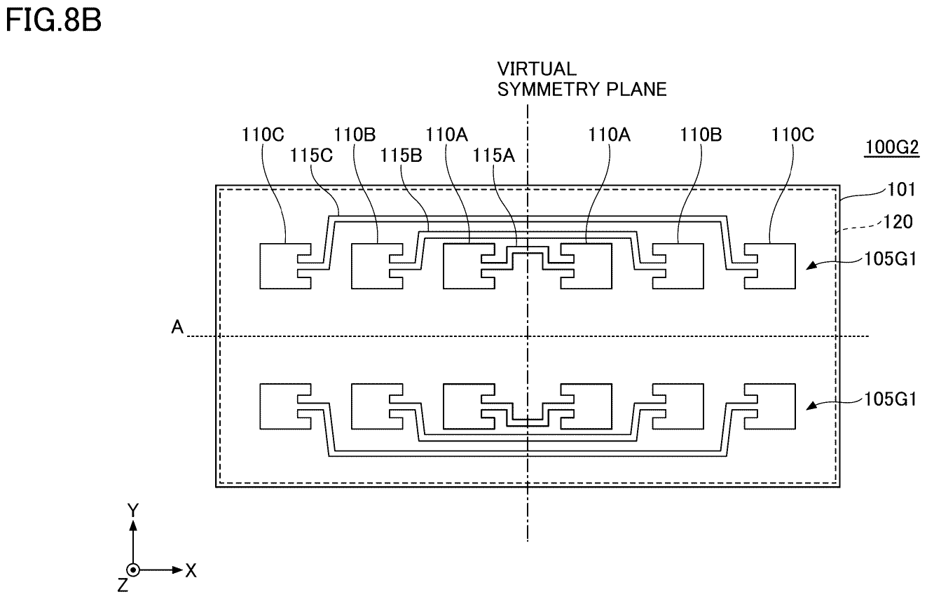

FIG. 8A is a diagram illustrating an example of the configuration of a radio wave reflector 100G1 according to the seventh modification of the first embodiment.

As illustrated in FIG. 8A, the radio wave reflector 100G1 includes a substrate 101, two antenna elements 110A, two antenna elements 110B, two antenna elements 110C, transmission lines 115A, 115B, and 115C, and a ground layer 120. In the radio wave reflector 100G1, the ground layer 120 is common with respect to the two antenna elements 110A, the two antenna elements 110B, the two antenna elements 110C, and the transmission lines 115A, 115B, and 115C.

The radio wave reflector 100G1 has a configuration in which the transmission lines 115A, 115B, and 115C are connected to sides extending in the Y direction on the +X direction side of the antenna elements 110A, 110B, and 110C located on the −X direction side of the virtual symmetry plane, and the transmission lines 115A, 115B, and 115C are connected to sides extending in the Y direction on the −X direction side of the antenna elements 110A, 110B, and 110C located on the +X direction side of the virtual symmetry plane.

The two antenna elements 110A, the two antenna elements 110B, the two antenna elements 110C, and the transmission line 115A, 115B, and 115C constitute an antenna 105G1.

In the radio wave reflector 100G1 described above, the two antenna elements 110A, the two antenna elements 110B, and the two antenna elements 110C are excited in the X direction. For example, when the radio wave reflector 100G1 is used in an upright position so that the +Y direction or the −Y direction is the vertically upward direction, the two antenna elements 110A, the two antenna elements 110B, and the two antenna elements 110C transmit and receive horizontally polarized radio waves.

The radio wave reflector 100G1 described above can arrange the transmission lines 115A, 115B, and 115C without intersecting the transmission lines 115A, 115B, and 115C. In addition, because the transmission lines 115A, 115B, and 115C can be arranged without intersecting one another, interference and impedance mismatch of the transmission lines 115A, 115B, and 115C can be suppressed, and favorable reflection characteristics of the two antenna elements 110A, the two antenna elements 110B, and the two antenna elements 110C can be obtained.

Accordingly, it is possible to provide the radio wave reflector 100G1 having the transmission lines 115A, 115V, and 115C that can be arranged without intersecting one another, and exhibiting favorable reflection characteristics.

The radio wave reflector may include a plurality of antennas 105G1. FIG. 8B is a diagram illustrating an example of the configuration of a radio wave reflector 100G2 according to the seventh modification of the first embodiment.

The radio wave reflector 100G2 includes a substrate 101, two antennas 105G1, and a ground layer 120. The substrate 101 and the ground layer 120 are common with respect to the two antennas 105G1.

The two antennas 105G1 are provided side by side in the Y direction. The arrangement of the two antenna elements 110A, the two antenna elements 110B, the two antenna elements 110C, and the transmission lines 115A, 115B, and 115C in the antenna 105G1 on the −Y direction side is identical to the arrangement in the antenna 105G1 illustrated in FIG. 8A.

The arrangement of the two antenna elements 110A, the two antenna elements 110B, and the two antenna elements 110C, and the transmission lines 115A, 115B, and 115C in the antenna 105G1 on the +Y direction side is mirror symmetric to the arrangement of the two antenna elements 110A, the two antenna elements 110B, the two antenna elements 110C, and the transmission lines 115A, 115B, and 115C in the antenna 105G1 on the −Y direction side, with respect to a straight line A that passes through the center of the two antennas 105G1 in the Y direction and is parallel to the X axis.

The radio wave reflector 100G2 described above can arrange the transmission lines 115A, 115B, and 115C without intersecting the transmission lines 115A, 115B, and 115C in each of the two antennas 105G1. In addition, because the transmission lines 115A, 115B, and 115C can be arranged without intersecting one another, interference and impedance mismatch of the transmission lines 115A, 115B, and 115C can be suppressed, and in each of the two antennas 105G1, favorable reflection characteristics of the two antenna elements 110A, the two antenna elements 110B, and the two antenna elements 110C can be obtained.

Accordingly, it is possible to provide the radio wave reflector 100G2 having the transmission lines 115A, 115B, and 115C that can be arranged without intersecting one another, and exhibiting favorable reflection characteristics.

### Second Embodiment

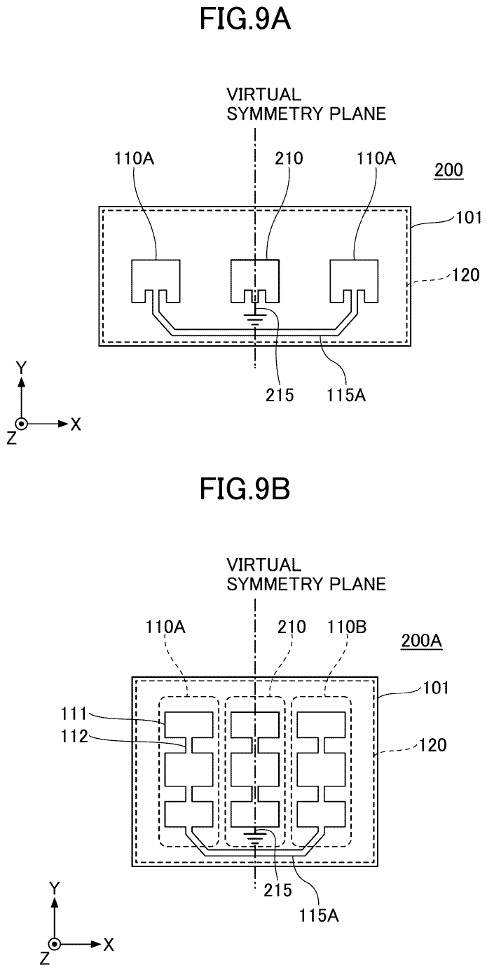

FIG. 9A is a diagram illustrating an example of the configuration of a radio wave reflector 200 according to a second embodiment. The radio wave reflector 200 includes a substrate 101, two antenna elements 110A, an antenna elements 210, transmission lines 115A and 215, and a ground layer 120. In this example, a description will be made for a case where a virtual symmetry plane parallel to the YZ plane is located at a center of the radio wave reflector 200 along the X direction. The antenna element 210 is an example of a second antenna element, and the transmission line 215 is an example of a second transmission line.

The substrate 101 and the ground layer 120 have sizes that are different from those of the substrate 101 and the ground layer 120 of the radio wave reflector 100 according to the first embodiment, but the configurations of the substrate 101 and the ground layer 120 are the same as those of the radio wave reflector 100. The two antenna elements 110A and the transmission line 115A are identical to the two antenna elements 110A and the transmission line 115A of the radio wave reflector 100 according to the first embodiment.

The radio wave reflector 200 according to the second embodiment includes the antenna element 210 and the transmission line 215 in place of the two antenna elements 110B, the two antenna elements 110C, and the transmission lines 115B and 115C of the radio wave reflector 100 according to the first embodiment. The radio wave reflector 200 is a reflector that performs retroreflection to reflect incoming radio waves from various directions on the +Z direction side toward the directions of arrival, for example.

### Antenna Element 210

The antenna element 210 may be any type of antenna element as long as the antenna element 210 has directivity in the +Z direction, but a case where the antenna element is a patch antenna will be described as an example. The antenna element 210 constitutes the patch antenna together with the ground layer 120. The patch antenna has directivity in a direction (+Z direction) from the ground layer 120 toward the antenna element 210, and thus, favorable reflection characteristics can be obtained.

Further, in a case where the radio wave reflector 200 is used as a reflector for an in-vehicle ultra-wideband radar, for example, the frequency of the radio waves is 79 GHz, for example. However, usage of the radio wave reflector 200 is not limited to such usage.

In this example, a case where the shape of the antenna element 210 in the plan view is a rectangular shape will be described, but the shape is not limited to the rectangular shape, and may be a circular shape, an elliptical shape, or the like. The shape of the antenna element 210 in the plan view may be different from those of the two antenna elements 110A. The antenna element 210 can be manufactured by patterning a conductive layer formed on the surface of the substrate 101 on the +Z direction side by wet etching or the like, together with the two antenna elements 110A, for example.

One end of the transmission line 215 is connected to the antenna element 210. The other end of the transmission line 215 is connected to the ground (reference potential point), for example. More specifically, the other end of the transmission line 215 is connected to the ground layer 120 through a via penetrating the substrate 101 in the Z direction, for example. The other end of the transmission line 215 may be an open end instead of being connected to the ground. The other end of the transmission line 215 is an example of an end of the transmission line 215.

The antenna element 210 has the same shape as the antenna element 110A, for example, and the transmission line 215 is connected to the antenna element 210 from the −Y direction side, for example. For this reason, the excitation direction of the antenna element 210 is the Y direction, for example. When the radio wave reflector 200 is used in the upright position so that the +Y direction or the −Y direction is vertically upward, for example, the antenna element 210 transmits and receives vertically polarized radio waves together with the antenna element 110A.

When the antenna element 210 receives the radio waves, signals of the received radio waves are transmitted through the transmission line 215, reflected at the end and returned to the antenna element 210, and the antenna element 210 transmits the radio waves, thereby reflecting the received radio waves. In this manner, the antenna element 210 performs retroreflection to reflect incoming radio waves in the directions of arrival, similar to the two antenna elements 110A.

The antenna element 210 is provided on the surface of the substrate 101 on the +Z direction side so that the center of the antenna element 210 in the plan view is located on the virtual symmetry plane. The antenna element 210 is provided at a center position between the two antenna elements 110A. The center position between the two antenna elements 110A is a center position between centers of the two antenna elements 110A in the plan view (a midpoint on a straight line connecting the two centers). The antenna element 210 being provided at the center position between the two antenna elements 110A means that the center of the antenna element 210 in the plan view is located at the center position between the two antenna elements 110A. The centers of gravity in the plan view may be used in place of the centers of the antenna element 210 and the two antenna elements 110A in the plan view.

### Transmission Line 215

The transmission line 215 has a characteristic impedance matching an input impedance of the antenna element 210. When the electrical length of the wavelength of the radio waves transmitted and received by the antenna element 210 is denoted by λe and an arbitrary natural number is denoted by N, the difference in length between the transmission line 115A and the transmission line 215 is λe×N−λe/2 in a case where the transmission line 215 has an end connected to the ground. The term λe/2 is subtracted because the phase of the signal is shifted by 180 degrees when the signal is reflected at the end connected to the ground. In the case where the transmission line 215 has the end connected to the ground, reflection phases of the two antenna elements 110A and 210 can be aligned by setting the length difference as described above.

In addition, in a case where the transmission line 215 has the open end, the length difference between the transmission line 115A and the transmission line 215 can be set to λe×N because the phase of the signal is not shifted at the open end. In the case where the transmission line 215 has the open end, the reflection phases of the two antenna elements 110A and 210 can be aligned by setting the length difference as described above.

The radio wave reflector according to the second embodiment may have a configuration illustrated in FIG. 9B. FIG. 9B is a diagram illustrating an example of the configuration of a radio wave reflector 200A according to the second embodiment. In the radio wave reflector 200A illustrated in FIG. 9B, the configurations of the two antenna elements 110A and the antenna element 210 of the radio wave reflector 200 illustrated in FIG. 9A are the same as those of the antenna elements 110A and 110B of the radio wave reflector 100B illustrated in FIG. 3B, and have a configuration in which the three rectangular radiating elements 111 arranged in the Y direction are connected by the line 112. Even when the antenna elements 110A and 210 having the configuration illustrated in FIG. 9B are used, the radio wave reflector 200A can operate in the same manner as the radio wave reflector 200 illustrated in FIG. 9A, and retroreflection can be achieved.

### Advantageous Features or Effects

The radio wave reflector 200 includes the two antenna elements 110A (two first antenna elements) provided along the X direction (first direction), the transmission line 115A (first transmission line) connecting the two antenna elements 110A, the antenna element 210 (second antenna element) disposed at the center position between the two antenna elements 110A in the X direction (first direction), and the transmission line 215 (second transmission line) connected to the antenna element 210 and having the end connected to the ground or the open end, and when the transmission wavelength (electrical length) of the radio waves transmitted and received by the two antenna elements 110A and the antenna element 210 is denoted by λe and the arbitrary natural number is denoted by N, the difference in electrical length between the transmission line 115A and the transmission line 215 is λe×N−λe/2 in the case where the transmission line 215 has the end connected to the ground, and is λe×N in the case where the transmission line 215 has the open end.

For this reason, retroreflection can be performed with the reflection phases aligned between the two antenna elements 110A and the antenna element 210. In addition, because the difference in length between the transmission lines 115A and 215 is λe×N and the transmission line 115A is longer than the transmission line 215, the transmission lines 115A and 215 can be arranged without intersecting each other. In addition, because the transmission lines 115A and 215 can be arranged without intersecting each other, the interference and the impedance mismatch between the transmission lines 115A and 215 can be suppressed, and favorable reflection characteristics of the two antenna elements 110A and 210 can be obtained.

Accordingly, it is possible to provide the radio wave reflector 200 having the transmission lines 115A and 215 that can be arranged without intersecting each other, and exhibiting favorable reflection characteristics.

In addition, the antenna element may further include the substrate 101 (wiring board), and the two antenna elements 110A, the transmission line 115A, the antenna element 210, and the transmission line 215 may be formed using a conductive layer provided on one surface of the substrate 101. A multilayer board does not need to be used, and a single-sided printed circuit board having the two antenna elements 110A, the transmission line 115A, the antenna element 210, and the transmission line 215 formed on one surface thereof can be used as the substrate 101. The radio wave reflector 200 having a simple configuration and a low manufacturing cost can be provided. Further, by using the single-sided printed circuit board as the substrate 101, the radio wave reflector 200 can be made thin.

Moreover, the radio wave reflector may further include the ground layer 120 provided on the other surface of the substrate 101. It is not necessary to use a multilayer board, and a double-sided printed circuit board having the two antenna elements 110A, the transmission line 115A, the antenna element 210, and the transmission line 215 formed on one surface and the ground layer 120 formed on the other surface can be used as the substrate 101. The radio wave reflector 200 having a simple configuration and a low manufacturing cost can be provided. Further, by using the double-sided printed circuit board as the substrate 101, the radio wave reflector 200 can be made thin.

Further, the two antenna elements 110A, the antenna element 210, and the ground layer 120 may constitute a patch antenna. By using the patch antenna having directivity in the direction from the ground layer 120 toward the two antenna elements 110A and the antenna element 210, the radio wave reflector 200 exhibiting favorable reflection characteristics can be provided.

In addition, the outer edge of the ground layer 120 may surround at least the two antenna elements 110A and the antenna element 210 in the plan view, and when the wavelength of radio waves is denoted by λ, the gap between the outer edge of the ground layer 120 and the outer edges of the two antenna elements 110A and the antenna element 210 in the excitation direction (Y direction) of the two antenna elements 110A and the antenna element 210 may be less than λ. By reducing the radio waves with the opposite phase due to the secondary inductive radiation generated in the ground layer 120, it is possible to suppress the radio waves radiated from the two antenna elements 110A and the antenna element 210 from being canceled out and to suppress a decrease in the radiation intensity in the +Z direction. For this reason, the radio wave reflector 200 having a large radiation intensity in the +Z direction can be provided.

The features of the first through seventh modifications of the first embodiment can also be applied to the radio wave reflector 200 according to the second embodiment.

According to the present disclosure, it is possible to provide a radio wave reflector with favorable reflection characteristics without having to arrange transmission lines to intersect one another.

Although the modifications of the first embodiment are numbered with, for example, “first,” “second,” “third,” “fourth,” “fifth,” “sixth,” or “seventh,” the ordinal numbers do not imply priorities of the modifications.

Although the radio wave reflector according to exemplary embodiments of the present disclosure is described above, the present disclosure is not limited to the specifically disclosed embodiments, and various variations, modifications, and substitutions may be made without departing from the scope of the present disclosure.

What is claimed is:

1. A radio wave reflector comprising:
two first antenna elements provided along a first direction;
a first transmission line connecting the two first antenna elements;
two second antenna elements arranged at positions equidistant from a center point between the two first antenna elements in the first direction and sandwich the two first antenna elements along the first direction; and
a second transmission line connecting the two second antenna elements, wherein a difference in electrical length between the first transmission line and the second transmission line is λe×N, where λe denotes a transmission wavelength of radio waves transmitted and received by the two first antenna elements and the two second antenna elements in electrical length, and N denotes an arbitrary natural number.

2. The radio wave reflector as claimed in claim 1, further comprising:
a wiring board,
wherein the two first antenna elements, the first transmission line, the two second antenna elements, and the second transmission line are formed of a conductive layer provided on one surface of the wiring board.

3. The radio wave reflector as claimed in claim 2, further comprising:
a ground layer provided on the other surface of the wiring board.

4. The radio wave reflector as claimed in claim 3, wherein each of the two first antenna elements, each of the two second antenna elements, and the ground layer constitute a patch antenna.

5. The radio wave reflector as claimed in claim 3, wherein:
an outer edge of the ground layer surrounds at least the two first antenna elements and the two second antenna elements in a plan view, and
a gap between an outer edge of the ground layer and outer edges of the two first antenna elements and the two second antenna elements in an excitation direction of the two first antenna elements and the two second antenna elements is less than λ, where λ denotes a wavelength of the radio waves.

6. The radio wave reflector as claimed in claim 3, wherein the ground layer has a slit or a slot provided at a position between the two first antenna elements or at a position between the two first antenna elements and the two second antenna elements in a plan view.

7. The radio wave reflector as claimed in claim 3, wherein the ground layer is divided into a portion overlapping the two first antenna elements and the first transmission line, and a portion overlapping the two second antenna elements and the second transmission line.

8. The radio wave reflector as claimed in claim 1, further comprising:
a plurality of antennas, each antenna of the plurality of antennas including the two first antenna elements, the first transmission line, the two second antenna elements, and the second transmission line,
wherein the plurality of antennas is arranged in the first direction or a second direction perpendicular to the first direction in a plan view.

9. The radio wave reflector as claimed in claim 1, further comprising:
a plurality of antennas, each antenna of the plurality of antennas including the two first antenna elements, the first transmission line, the two second antenna elements, and the second transmission line,
wherein the plurality of antennas is arranged in a matrix.

10. A radio wave reflector comprising:
two first antenna elements provided along a first direction;
a first transmission line connecting the two first antenna elements;
a second antenna element disposed at a center position between the two first antenna elements in the first direction; and
a second transmission line connected to the second antenna element and having an end coupled to ground or an open end,
wherein a difference in electrical length between the first transmission line and the second transmission line is λe×N−λe/2 in a case where the second transmission line has the end coupled to the ground, and is λe×N in a case where the second transmission line has the open end, where λe denotes a transmission wavelength of radio waves transmitted and received by the two first antenna elements and the second antenna element in electrical length, and N denotes an arbitrary natural number.

11. The radio wave reflector as claimed in claim 10, further comprising:
a wiring board,
wherein the two first antenna elements, the first transmission line, the second antenna element, and the second transmission line are formed of a conductive layer provided on one surface of the wiring board.

12. The radio wave reflector as claimed in claim 11, further comprising:
a ground layer provided on the other surface of the wiring board.

13. The radio wave reflector as claimed in claim 12, wherein each of the two first antenna elements, the second antenna element, and the ground layer constitute a patch antenna.

14. The radio wave reflector as claimed in claim 12, wherein:
an outer edge of the ground layer surrounds at least the two first antenna elements and the second antenna element in a plan view, and
a gap between the outer edge of the ground layer and outer edges of the two first antenna elements and the second antenna element in an excitation direction of the two first antenna elements and the second antenna element is less than λ, where λ denotes a wavelength of the radio waves.

15. The radio wave reflector as claimed in claim 12, wherein the ground layer has a slit or a slot provided at a position between the two first antenna elements or at a position between the two first antenna elements and the second antenna element in a plan view.

16. The radio wave reflector as claimed in claim 12, wherein the ground layer is divided into a portion overlapping the two first antenna elements and the first transmission line, and a portion overlapping the second antenna element and the second transmission line.

17. The radio wave reflector as claimed in claim 10, further comprising:
a plurality of antennas, each antenna of the plurality of antennas including the two first antenna elements, the first transmission line, the second antenna element, and the second transmission line,
wherein the plurality of antennas is arranged in the first direction or a second direction perpendicular to the first direction in the plan view.

18. The radio wave reflector as claimed in claim 10, further comprising:
a plurality of antennas, each antenna of the plurality of antennas including the two first antenna elements, the first transmission line, the second antenna element, and the second transmission line,
wherein the plurality of antennas is arranged in a matrix.
